(19) United States
(12) Patent Application Publication
(10) Pub. No.: US 2021/0175937 A1
(43) Pub. Date: Jun. 10, 2021

(54) BASE STATION APPARATUS, TERMINAL APPARATUS, AND COMMUNICATION METHOD

(71) Applicants: SHARP KABUSHIKI KAISHA, Sakai City, Osaka (JP); FG Innovation Company Limited, Tuen Mun, New Territories (HK)

(72) Inventors: RYOTA YAMADA, Sakai City, Osaka (JP); HIROMICHI TOMEBA, Sakai City, Osaka (JP)

(21) Appl. No.: 17/255,269

(22) PCT Filed: May 31, 2019
(86) PCT No.: PCT/JP2019/021867

§ 371 Date: Dec. 22, 2020

(30) Foreign Application Priority Data
Jun. 28, 2018 (JP) 2018-123021

(51) Int. Cl. H04B 7/0417; H04B 7/06; H04L 5/00; H04B 7/0456

(52) U.S. Cl. CPC H04B 7/0417; H04B 7/0626; H04B 7/0486; H04B 7/0632; H04B 7/0639; H04L 5/0048

(57) ABSTRACT

A base station apparatus, a terminal apparatus, and a communication method are provided in which reliability, frequency efficiency, or throughput can be improved in a case that transmission is performed based on beam forming. For a first CRI indicating a first CSI-RS resource and a second CRI indicating a second CSI-RS resource, the first and second CRIs being simultaneously receivable by the terminal apparatus, a first RI for the first CRI and a second RI for the second CRI are determined, and in a case that a total of the first RI and the second RI is four or less, a CQI determined by using both the first CRI and the second CRI is determined, and in a case that the total of the first RI and the second RI is greater than four, a first CQI determined by using the first CRI and a second CQI determined by using the second CRI are determined.

### TECHNICAL FIELD

The present invention relates to a base station apparatus, a terminal apparatus, and a communication method. This application claims priority based on JP 2018-123021 filed on Jun. 28, 2018, the contents of which are incorporated herein by reference.

### BACKGROUND ART

Research and development activities related to the 5th generation mobile radio communication system (5G system) have been actively carried out, aiming to start commercial services around the year 2020. A vision recommendation on the standard system of the 5G system (International mobile telecommunication—2020 and beyond: IMT-2020) was recently reported (see NPL 1) by the International Telecommunication Union Radio communications Sector (ITU-R), which is an international standardization body.

Providing sufficient frequency resources is an important issue for a communication system to handle a rapid increase in data traffic. Thus, one of the targets for 5G is to achieve ultra large-capacity communication using frequency bands higher than the frequency bands used in Long term evolution (LTE). However, in radio communication using high frequency bands, path loss is a problem. Beamforming based on multiple antennas is a promising technique for compensation for the path loss, (see NPL 2).

### CITATION LIST

### Non Patent literature

NPL 1: “IMT Vision—Framework and overall objectives of the future development of IMT for 2020 and beyond,” Recommendation ITU-R M. 2083-0, September 2015.

NPL 2: E. G. Larsson, O. Edfors, F. Tufvesson, and T. L. Marzetta, “Massive MIMO for next generation wireless system,” IEEE Commun. Mag., vol. 52. no. 2, pp. 186-195, February 2014.

### SUMMARY OF INVENTION

### Technical Problem

However, beamforming especially in high frequency bands may pose a problem in terms of reliability, frequency efficiency, or throughput, for example, blocking by a person or an object may lead to interception of a channel or for example, high spatial correlation attributed to a Line of Sight (LOS) environment may lead to low rank communication.

In view of such circumstances, an object of the present invention is to provide a base station apparatus, a terminal apparatus, and a communication method in which, in a case that the base station apparatus or the terminal apparatus performs a transmission based on beamforming. reliability, frequency efficiency, or throughput can be improved.

### Solution to Problem

To address the above-mentioned drawbacks, a base station apparatus, a terminal apparatus, and a communication method according to an aspect of the present invention are configured as follows.

A terminal apparatus according to an aspect of the present invention is a terminal apparatus for communicating with a base station apparatus, the terminal apparatus including: a higher layer processing unit configured to be configured with a channel state information (CSI) report configuration; a measurement unit configured to calculate CSI; and a transmitter configured to transmit a CSI report, wherein, in a case that, in the CSI report configuration, a report quantity is configured so as to report a CSI-RS resource indicator (CRI), a rank indicator (RI), and a channel quality indicator (CQI) and group-based beam reporting is ON, for a first CRI indicating a first CSI-RS resource and a second CRI indicating a second CSI-RS resource, the first and second CRIs being included in multiple CSI-RS resources configured in a CSI-RS resource set, and being simultaneously receivable by the terminal apparatus, a first RI for the first CRI and a second RI for the second CRI are determined, and in a case that a total of the first RI and the second RI is four or less, a CQI determined by using both the first CRI and the second CRI is determined, and in a case that the total of the first RI and the second RI is greater than four, a first CQI determined by using the first CRI and a second CQI determined by using the second CRI are determined.

In the terminal apparatus according to an aspect of the present invention, the RI to be reported is the total of the first RI and the second RI.

In the terminal apparatus according to an aspect of the present invention, in a case that, in the CSI report configuration, the report quantity is configured so as to report the CRI, the RI a precoding matrix indicator (PMI), and the CQI and the group-based beam reporting is ON, a first PMI for the first CRI and a second PMI for the second CRI are further determined, and the first PMI and the second PMI are calculated in consideration of both the first CRI and the second CRI.

In the terminal apparatus according to an aspect of the present invention, a difference between the first RI and the second RI is zero or one.

In the terminal apparatus according to an aspect of the present invention, in a case that a difference between the first HI and the second RI is other than zero or one, either the CSI based on the first CRI or the CSI based on the second CRI is reported.

In the terminal apparatus according to an aspect of the present invention, information indicating whether to report, the CSI based on one CRI or report the CSI based on two CRIs is included in the CSI report.

A base station apparatus according to an aspect of the present invention is a base station apparatus for communicating with a terminal apparatus, the base station apparatus including: a higher layer processing unit configured with a channel state information (CSI) report configuration; and a receiver configured to receive a CSI report, wherein, in a case that, in the CSI report configuration, a report quantity is configured so as to report a CSI-RS resource indicator (CRI), a rank indicator (RI), and a channel quality indicator (CQI) and group-based beam reporting is ON, for a first CRI indicating a first CSI-RS resource and a second CRI indicating a second CSI-RS resource, the first and second CRIs being included in multiple CSI-RS resources configured in a CSI-RS resource set, and being simultaneously receivable by the terminal apparatus, information indicating a first RI for the first CRI and a second RI for the second CRI is received, and in a case that a total of the first RI and the second RI is four or less, a CQI determined by using both the first CRI and the second CRI is received, and in a case that the total of the first RI and the second RI is greater than four, a first CQI determined by using the first CRI and a second CQI determined by using the second CRI are received.

In the base station apparatus according to an aspect of the present invention, the RI to be received is the total of the first RI and the second RI.

In the base station apparatus according to an aspect of the present invention, in a case that, in the CSI report configuration, the report quantity is configured so as to report the CRI, the RI, a precoding matrix indicator (PMI), and the CQI and the group-based beam reporting is ON, a first PMI for the first CRI and a second PMI for the second CRI are further determined, and the first PMI and the second PMI are calculated in consideration of both the first CRI and the second CRI.

In the base station apparatus according to an aspect of the present invention, a difference between the first RI and the second RI is zero or one.

In the base station apparatus according to an aspect of the present invention, in a case that a difference between the first RI and the second RI is other than zero or one, either the CSI based on the first CRI or the CSI based on the second CRI is received.

In the base station apparatus according to an aspect of the present invention, information indicating whether to report the CSI based on one CRI or to report the CSI based on two CRIs is received.

A communication method according to an aspect of the present invention is a communication method in a terminal apparatus for communicating with a base station apparatus, the communication method including the steps of: causing a channel state information (CSI) report configuration to be configured; calculating CSI; and transmitting a CSI report, wherein, in a case that, in the CSI report configuration, a report quantity is configured so as to report a CSI-RS resource indicator (CRI), a rank indicator (RI), and a channel quality indicator (CQI) and group-based beam reporting is ON, for a first CRI indicating a first CSI-RS resource and a second CRI indicating a second CSI-RS resource, the first and second CRIs being included in multiple CSI-RS resources configured in a CSI-RS resource set, and being simultaneously receivable by the terminal apparatus, a first RI for the first CRI and a second RI for the second CRI are determined, and in a case that a total of the first RI and the second RI is four or less, a CQI determined by using both the first CRI and the second CRI is determined, and in a case that the total of the first RI and the second RI is greater than four, a first CQI determined by using the first CRI and a second CQI determined by using the second CRI are determined.

A communication method according to an aspect of the present invention is a communication method in a base station apparatus for communicating with a terminal apparatus, the communication method including the steps of: causing a channel state information (CSI) report configuration to be configured; and receiving a CSI report, wherein, in a case that, in the CSI report configuration, a report quantity is configured so as to report a CSI-RS resource indicator (CRI), a rank indicator (RI), and a channel quality indicator (CQI) and group based beam reporting is ON, fora first CRI indicating a first CSI-RS resource and a second CRI indicating a second CSI-RS resource, the first and second CRIs being included in multiple CSI-RS resources configured in a CSI-RS resource set, and being simultaneously receivable by the terminal apparatus, information indicating a first RI for the first CRI and a second RI for the second CRI is received, and in a case that a total of the first RI and the second RI is four or less, a CQI determined by using both the first CRI and the second CRI is received, and in a case that the total of the first RI and the second RI is greater than four, a first CQI determined by using the first CRI and a second CQI determined by using the second CRI are received.

### Advantageous Effects of Invention

According to an aspect of the present invention, in a case that a base station apparatus or a terminal apparatus communicates by beamforming, reliability, frequency efficiency, or throughput can be improved.

### BRIEF DESCRIPTION OF DRAWINGS

FIG. 1 is a diagram illustrating an example of a communication system according to the present embodiment.

FIG. 2 is a block diagram illustrating a configuration example of a base station apparatus according to the present embodiment.

FIG. 3 is a block diagram illustrating a configuration example of a terminal apparatus according to the present embodiment.

FIG. 4 is a diagram illustrating an example of a communication system according to the present embodiment.

### DESCRIPTION OF EMBODIMENTS

A communication system according to the present embodiment includes a base station apparatus (a transmitter, cells, a transmission point, a group of transmit antennas, a group of transmit antenna ports, a component carrier, an eNodeB, a transmission point, a transmission and/or reception point, a transmission panel, an access point, and a subarray) and a terminal apparatus (a terminal, a mobile terminal, a reception point, a reception terminal, a receiver, a group of receive antennas, a group of receive antenna pons. UE, a reception point, a reception panel, a station, and a subarray ). Furthermore, a base station apparatus connected to a terminal apparatus (base station apparatus that establishes a radio link with a terminal apparatus) is referred to as a serving cell.

The base station apparatus and the terminal apparatus in the present embodiment can communicate in a licensed band and/or an unlicensed band.

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

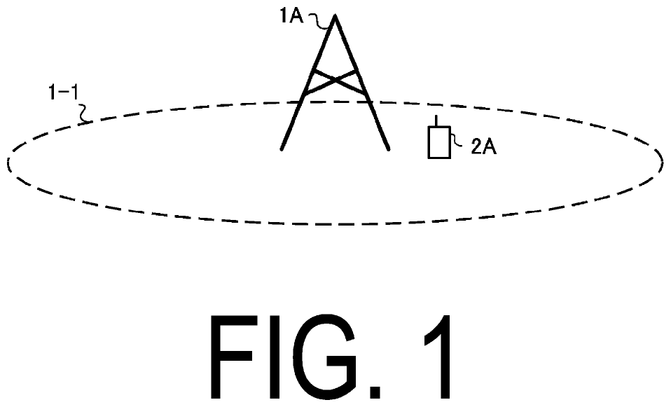

FIG. 1 is a diagram illustrating an example of a communication system according to the present embodiment. As illustrated in FIG. 1, the communication system according to the present embodiment includes a base station apparatus 1A and a terminal apparatus 2A. Coverage 1-1 is a range (a communication area) in winch the base station apparatus 1A can connect to the terminal apparatuses. The base station apparatus 1A is also simply referred to as a base station apparatus. The terminal apparatus 2A is also simply referred to as a terminal apparatus.

With respect to FIG. 1, the following uplink physical channels are used for uplink radio communication from the terminal apparatus 2A to the base station apparatus 1A. The uplink physical channels are used for transmitting information output from a higher layer.
Physical Uplink Control Channel (PUCCH)
Physical Uplink Shared Channel (PUSCH)

Physical Random Access Channel (PRACH)

PUCCH is used to transmit Uplink Control information (UCI), The Uplink Control Information includes a positive acknowledgement (ACK) or a negative acknowledgement (NACK) (ACK/NACK) for downlink data (a downlink transport block or a Downlink Shared Channel (DL-SCH)), ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared Channel (UL-SCH) resource. The Channel State Information refers to a Rank Indicator (RI) for specifying a preferable spatial multiplexing number, a Precoding Matrix Indicator (PMI) for specifying a preferable precoder, a Channel Quality indicator (CQI) for specifying a preferable transmission rate, a CSI-Reference Signal (RS) Resource Indicator (CRI) for indicating a preferable CSI-RS resource. Reference Signal Received Power (RSRP) measured by the CSI-RS or an SS (Synchronization Signal), and the like.

The Channel Quality Indicator (hereinafter, referred to as a CQI value) can be a preferable modulation scheme (e.g., QPSK, 16 QAM, 64 QAM, 256 QAM, or the like) and a preferable coding rate in a prescribed band (details of which will be described later). The CQI value can be an index (CQI Index) determined by the above described change modulation scheme, coding rate, and the like. The CQI value can take a value predetermined in the system.

The CRI indicates a CSI-RS resource for which received power/reception quality from multiple CSI-RS resources is preferable.

Note that the Rank Indicator and the Precoding Quality Indicator can take the values predetermined in the system. The Rank Indicator and the Precoding Matrix Indicator can be an index determined by the number of spatial multiplexing and Precoding Matrix information. Note that some or all of the CQI values, the PMI values, the RI values, and the CRT values are also collectively referred to as CSI values.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the uplink control information only.

PUSCH is used to transmit an RRC message. The RRC message is a signal/information that is processed in a Radio Resource Control (RRC) layer. Further, PUSCH is used to transmit a MAC Control Element (CE). Here, MAC CE is a signal/information that is processed (transmitted) in a Medium Access Control (MAC) layer.

For example, a power headroom may be included in MAC CE and may be reported via PUSCH. In other words, a MAC CE field may be used to indicate a level of the power headroom.

PRACH is used to transmit a random access preamble.

In the uplink radio communication, an Uplink Reference Signal (UL RS) is used as an uplink physical signal. The uplink physical signal is not used for transmission of information output from higher layers, but is used by the physical layer. Here, uplink reference signals include a Demodulation Reference Signal (DMRS), a Sounding Reference Signal (SRS), and a Phase-Tracking reference signal (PT-RS).

The DMRS is associated with transmission of the PUSCH or the PUCCH. For example, the base station apparatus 1A uses DMRS in order to perform channel compensation of PUSCH or PUCCH. For example, the base station apparatus 1A uses SRS to measure an uplink channel state. The SRS is used for observation (sounding) of the uplink. PT-RS is used to compensate for phase noise. Note that an uplink DMRS is also referred to as an uplink DMRS.

In FIG. 1, the following downlink physical channels are used for the downlink radio communication from the base station apparatus 1A to the terminal apparatus 2A. The downlink physical channels are used for transmitting information output from the higher layer.
Physical Broadcast Channel (PBCH)
Physical Control Format Indicator Channel (PCFICH)
Physical Hybrid automatic repeat request indicator Channel (PHICH)
Physical Downlink Control Channel (PDCCH)
Enhanced Physical Downlink Control Channel (EPDCCH)
Physical Downlink Shared Channel (PDSCH)

PBCH is used for broadcasting a Master Information Block (MIB, a Broadcast Channel (BCH)) that is used commonly by the terminal apparatuses. PCFICH is used for transmission of information for indicating a region (e.g., the number of Orthogonal Frequency Division Multiplexing (OFDM) symbols) to be used for transmission of PDDCH, Note that the MIB is also referred to as minimum system information.

PHICH is used for transmission of ACK/NACK with respect to uplink data (a transport block, a codeword) received by the base station apparatus 1A. In other words, PHICH is used for transmission of a HARQ indicator (HARQ feedback) for indicating ACK/NACK with respect to the uplink data. Note that ACK/NACK is also called HARQ-ACK. The terminal apparatus 2A reports ACK/NACK having been received to a higher layer. ACK/NACK refers to ACK for indicating a successful reception, NACK for indicating an unsuccessful reception, and DTX for indicating that no corresponding data is present. In a case that PHICH for uplink data is not present, the terminal apparatus 2A reports ACK to a higher layer.

PDCCH and the EPDCCH are used to transmit Downlink Control Information (DCI). Here, multiple DCI formats are defined for transmission of the downlink control information. To be more specific, a field for the downlink, control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, and a TPC command for PUCCH. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, and a TPC command for PUSCH. Here, the DCI format for the uplink is also referred to as uplink grant (or uplink assignment).

The DCI format for the uplink can be used to request Channel State Information (CSI; also referred to as reception quality information) for the downlink (CSI request).

The DCI format for the uplink can be used for a configuration for indicating an uplink resource to which a CSI feedback report is mapped, the CSI feedback report being fed hack to the base station apparatus by the terminal apparatus. For example, the CSI feedback report can be used for a configuration for indicating an uplink resource that periodically reports Channel State Information (Periodic CSI). The CSI feedback report can be used for a mode configuration (CSI report mode) for periodically reporting the Channel State Information.

For example, the CSI feedback report can be used for a configuration for indicating an uplink resource that reports aperiodic Channel State Information (Aperiodic CSI). The CSI feedback report can be used for a mode configuration (CSI report mode) for aperiodically reporting the Channel State Information.

For example, the CSI feedback report can be used for a configuration for indicating an uplink resource that reports semi persistent CSI. The CSI feedback report can be used for a mode configuration (CSI report mode) for semi-persistently reporting the Channel State Information. Note that the semi-persistent CSI report refers to periodic CSI reporting during a period from activation with higher layer signalling or downlink control information until deactivation.

The DCI format for the uplink can be used for a configuration for indicating a type of the CSI feedback report that is fed back to the base station apparatus by the terminal apparatus. The type of the CSI feedback report includes wideband CSI (e.g., Wideband CQI), narrowband CSI (e.g., Subband CQI), and the like.

In a case where a PDSCH resource is scheduled in accordance with the downlink assignment, the terminal apparatus receives downlink data on the scheduled PDSCH. In a case where a PDSCH resource is scheduled in accordance with the uplink grant, the terminal apparatus transmits uplink data and/or uplink control information on the scheduled PUSCH.

PDSCH is used to transmit the downlink data (the downlink transport block, DL-SCH). PDSCH is used to transmit a system information block type 1 message. The system information block type 1 message is cell specific information.

PDSCH is used to transmit a system information message. The system information message includes a system information block X other than the system information block type 1. The system information message is cell-specific information.

PDSCH is used 10 transmit an RRC message. Here, the RRC message transmitted from the base station apparatus may be shared by multiple terminal apparatuses in a cell. The RRC message transmitted front the base station apparatus 1A may be a dedicated message to a given terminal apparatus 2A (also referred to as dedicated signaling). In other words, user equipment-specific (user equipment unique) information is transmitted by using the message dedicated to the certain terminal apparatus. PDSCH is used to transmit MAC CE.

Here, the RRC message and/or MAC CE is also referred to as higher layer signaling.

PDSCH can be used to request downlink channel state information. PDSCH can be used for transmission of an uplink resource to which a CSI feedback report is mapped, the CSI feedback report being fed back to the base station apparatus by the terminal apparatus. For example, the CSI feedback report can be used for a configuration for indicating an uplink resource that periodically reports Channel State Information (Periodic CSI). The CSI feedback report can be used fora mode configuration (CSI report mode) for periodically reporting the Channel State Information.

The type of the downlink Channel State Information report includes wideband CSI (e.g., Wideband CSI) and narrowband CSI (e.g., Subband CSI). The wideband CSI calculates one piece of Channel State Information for the system band of a cell. The narrowband CSI divides the system baud in predetermined units, and calculates one piece of Channel State Information for each division.

In the downlink radio communication, a Synchronization Signal (SS) and a Downlink Reference Signal (DL RS) are used as downlink physical signals. The downlink physical signals are not used for transmission of information output from the higher layers, but are used by the physical layer. Note that the synchronization signals include a Primary Synchronization Signal (PSS) and a Secondary Synchronization Signal (SSS).

The synchronization signal is used for the terminal apparatus to take synchronization in the frequency domain and the time domain in the downlink. The synchronization signal is also used to measure received power, reception quality, or a Signal-to-Interference and Noise power Ratio (SINR). Note that the received power measured by the synchronization signal is referred to as Synchronization Signal Reference Signal Received Power (SS-RSRP) and that the reception quality measured by the synchronization signal is referred to as Reference Signal Received Quality (SS-RSRQ) and that the SINK measured by the synchronization signal is also referred to as SS-SINR. Note that SS-RSRQ is the ratio between SS-RSRP and RSSI. The Received Signal Strength Indicator (RSSI) is the total average received power during a certain observation period. The synchronization signal/downlink reference signal is used for the terminal apparatus to perform channel compensation for a downlink physical channel. For example, the synchronization signal/downlink reference signal is used for the terminal apparatus to calculate the downlink Channel State Information.

Here, the downlink reference signals include a Demodulation Reference Signal (DMRS), a Non-Zero Power Chanel State Information-Reference Signal (NZP CSI-RS), a Zero Power Chanel State Information-Reference Signal (ZP CSI-RS), PT-RS, and a Tracking Reference Signal (TRS). Note that DMRS in the downlink is also referred to as a downlink DMRS. Note that in the following embodiments, a simple reference to CSI-RS includes NZP CSI-RS and/or ZP CSI-RS.

DMRS is transmitted in a subframe or a band used to transmit PDSCH/PBCH/PDCCH/EPDCCH to which DMRS is related, and is used to demodulate PDSCH/PBCCH/PDCCH/EPDCCH with which DMRS is associated.

A resource for NZP CSI-RS is configured by the base station apparatus 1A. For example, the terminal apparatus 2A performs signal measurement (channel measurement) by using NZP CSI-RS, NZP CSI-RS is also used, for example, for beam scanning in which a preferable beam direction is searched for and beam recovery in which degraded received power/reception quality in the beam direction is recovered. A resource for ZP CSI-RS is configured by the base station apparatus 1A. With zero output, the base station apparatus 1A transmits ZP CSI-RS. For example, the terminal apparatus 2A performs interference measurement in a resource to which ZP CSI-RS corresponds. Note that the resource for the ZP CSI-RS to measure the corresponding interference is also referred to as a CSI-IM (Interference Measurement) resource.

The base station apparatus 1A transmits (configures) the NZP CSI-RS resource configuration for the resource for the NZP CSI-RS. The NZP CSI-RS resource configuration includes one or more NZP CSI-RS resource mappings, CSI-RS resource configuration IDs for the respective NZP CSI-RS resources, and some or all of the number of antenna ports. The CSI-RS resource mapping indicates information (for example, resource elements) indicating OFDM symbols or subcarriers in slots to which the CSI-RS resources are allocated. The CSI-RS resource configuration ID is used to identify the NZP CSI-RS resource configuration.

The base station apparatus 1A transmits (configures) the CSI-IM resource configuration. The CSI-IM resource configuration includes one or more CSI-IM resource mappings, and CSI-IM resource configuration IDs for the respective CSI-IM resources. The CSI-IM resource mapping indicates information (for example, resource elements) indicating OFDM symbols or subcarriers in slots to which the CSI-IM resources are allocated. The CSI-IM resource set configuration ID is used to specify the CSI-IM resource set configuration.

CSI-RS is also used to measure the received power, reception quality, or SINR. The received power measured by CSI-RS is also referred to as CSI-RSRP, the reception quality measured by CSI-RS is also referred to as CSI-RSRQ, and SINR measured by CSI-RS is also referred to as CSI-SINR. Note that CSI-RSRQ is a ratio between CSI-RSRP and RSSI.

Additionally, the CSI-RS is also transmitted periodically/aperiodically/semi-persistently.

For the CSI, the terminal apparatus is configured by a higher layer. Examples of such configuration include a CSI report configuration being a configuration of the CSI report, a CSI resource configuration being a configuration of the resource for measurement of the CSI, and a measurement link configuration linking the CSI report configuration with the CSI resource configuration for CSI measurement. One or more report configurations, resource configurations, and measurement link configurations are configured.

The CSI report configuration includes some or all of a report configuration ID, a report configuration type, a codebook configuration, a CSI report quantity, and a block error rate target. The report configuration ID is used to identify the CSI report configuration. The report configuration type indicates a periodic/aperiodic/semi-persistent CSI report. The CSI report quantity indicates the reported amounts (values or types), e.g., some or all of the CRI, RI, PMI, CQI, or RSRP. The block error rate target is a target of a block error rate that is assumed in a case that the CQI is calculated.

The CSI resource configuration includes some or all of a resource configuration ID, a synchronization signal block resource measurement list, a resource configuration type, or one or more resource set configurations. The resource configuration ID is used to identify the resource configuration. The synchronization signal block resource configuration list is a list of resources for which measurements are made using synchronization signals. The resource configuration type indicates whether the CSI-RS is transmitted periodically, a periodically, or semi-persistently. Note that in the case of a configuration in which the CSI-RS is transmitted semi-persistently, the CSI-RS is periodically transmitted during a period from activation with the higher layer signalling or downlink control information until deactivation.

The CSI-RS resource set configuration includes a part or all of information indicating a CSI-RS resource set configuration ID, resource repetition, and/or one or more CSI-RS resources. The resource set configuration ID is used to identify the CSI-RS resource set configuration. The resource repetition indicates on/off of resource repetition within the resource set. The resource repetition being on means that the base station apparatus uses a fixed (identical) transmit beam for each of multiple CSI-RS resources in the resource set. In other words, in a case that the resource repetition is on, the terminal apparatus assumes that the base station apparatus uses a fixed (identical) transmit beam for each of multiple CSI-RS resources in the resource set. The resource repetition being off means that the base station apparatus does not use a fixed (identical) transmit beam for each of multiple CSI-RS resources in the resource set. In other words, in a case that the resource repetition is off, the terminal apparatus assumes that the base station apparatus does not use a fixed (identical) transmit beam for each of multiple CSI-RS resources in the resource set. The information indicating CSI-RS resources includes one or more CSI-RS resource configuration IDs, one or more CSI-IM resource configuration IDs.

The measurement link configuration includes some or all of the measurement link configuration ID, the report configuration ID, and the resource configuration ID, and the CSI report configuration and the CSI resource configuration are linked. The measurement link configuration ID is used to identify the measurement link configuration.

The PT-RS is associated with the DMRS (DMRS port group). The number of antenna ports for the PT-RS is 1 or 2, and each PT-RS port is associated with the DMRS port group. The terminal apparatus assumes that the PT-RS port and the DMRS port are quasi co-located for a delay spread, a Doppler spread, a Doppler shift, an average delay, and spatial reception (Rx) parameters. The base station apparatus configures the PT-RS configuration by using the higher layer signaling. In a case that the PT-RS configuration is made, the PT-RS may be transmitted. The PT-RS is not transmitted in a case of a prescribed MCS (e.g., in a case that the modulation scheme is QPSK). For the PT-RS configuration, a time density and a frequency density are configured. The time density indicates the time intervals at which the PT-RS is allocated. The time density is indicated as a function of the scheduled MCS. The time density also includes the lack of the PT-RS (not transmitted). The frequency density indicates the frequency intervals at which the PT-RS is allocated. The frequency density is indicated as a function of the scheduled bandwidth. The frequency density also includes the lack of the PT-RS (not transmitted). Note that, in a case that the time density or frequency density indicates the lack of the PT-RS (not transmitted), no PT-RS is present (no PT-RS is transmitted).

The Multimedia Broadcast multicast service Single Frequency Network (MBSFN) RS is transmitted across the band of the subframe used for transmitting PMCH.

MBSFN RS is used to demodulate PMCH. PMCH is transmitted through the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel The downlink physical signal and the uplink physical signal are also collectively referred to as a physical signal.

BCH, UL-SCH, and DT-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are perforated for each codeword.

Furthermore, for terminal apparatuses that supports Carrier Aggregation (CA), the base station apparatus can integrate multiple Component Carriers (CCs) for transmission in a broader band to perform communication. In carrier aggregation, one Primary Cell (PCell) and one or more Secondary Cells (SCells) are configured as a set of serving cells.

Furthermore, in Dual Connectivity (DC), a Master Cell Group (MCG) and a Secondary Cell Group (SCG) are configured as a group of serving cells. MCG includes a PCell and optionally one or more SCells. Furthermore, SCG includes a primary SCell (PSCell) and optionally one or more SCells.

The base station apparatus can communicate by using a radio frame. The radio frame includes multiple subframes (sub-periods). In a case that a frame length is expressed in time, for example, a radio frame length can be 10 milliseconds (ms), and a subframe length can be 1 ms. In this example, the radio frame includes 10 subframes.

The slot includes 14 OFDM symbols. Since the OFDM symbol length can vary depending on the subcarrier spacing, the slot length may also vary depending on the subcarrier spacing. The mini-slot includes fewer OFDM symbols than the slot. The slot/mini slot can be used as a scheduling unit. Note that the terminal apparatus can recognize slot-based scheduling/mini-slot-based scheduling from the position (allocation) of the first downlink DMRS. In the slot-based scheduling, the first downlink DMRS is allocated to the third or fourth symbol in the slot. In the mini-slot-based scheduling, the first downlink DMRS is allocated to the first symbol in the scheduled data (resource. PDSCH). Note that the slot-based scheduling is also referred to as a PDSCH mapping type A. The mini-slot-based scheduling is also referred to as a PDSCH mapping type B.

The resource block is defined by 12 continuous subcarriers. The resource element is defined by an index in the frequency domain (e.g., a subcarrier index) and an index in the time domain (e.g., OFDM symbol index). The resource element is classified as an uplink resource element, a downlink element, a flexible resource element, or a reserved resource element. In the reserved resource element, the terminal apparatus does not transmit uplink signals or not receive downlink signals.

Multiple Subcarrier spacings (SOS) are supported. For example, the SCS is 15/30/60/120/240/480 kHz.

The base station apparatus/terminal apparatus can communicate in a licensed band or an unlicensed band. For the base station apparatus/terminal apparatus, the licensed band is used as a PCell, and communication with at least one SCell operating in the unlicensed band can be performed through carrier aggregation. The base station apparatus/terminal apparatus can communicate through dual connectivity in which a master cell group communicates in the licensed band and a secondary cell group communicates in the unlicensed band. The base station apparatus/terminal apparatus can communicate in the unlicensed band by using only the PCell. The base station apparatus/terminal apparatus can communicate through CA or DC only in the unlicensed band. Note that communication performed with the licensed band being used as a PCell and with a cell in the unlicensed band (SCell or PSCell) being assisted by, for example, CA or DC is also referred to as Licensed-Assisted Access (LAA). Communication performed by the base station apparatus/terminal apparatus only in the unlicensed band is also referred to as Unlicensed-standalone access (ULSA). Communication performed by the base station apparatus/terminal apparatus only in the licensed band is also referred to as Licensed Access (LA).

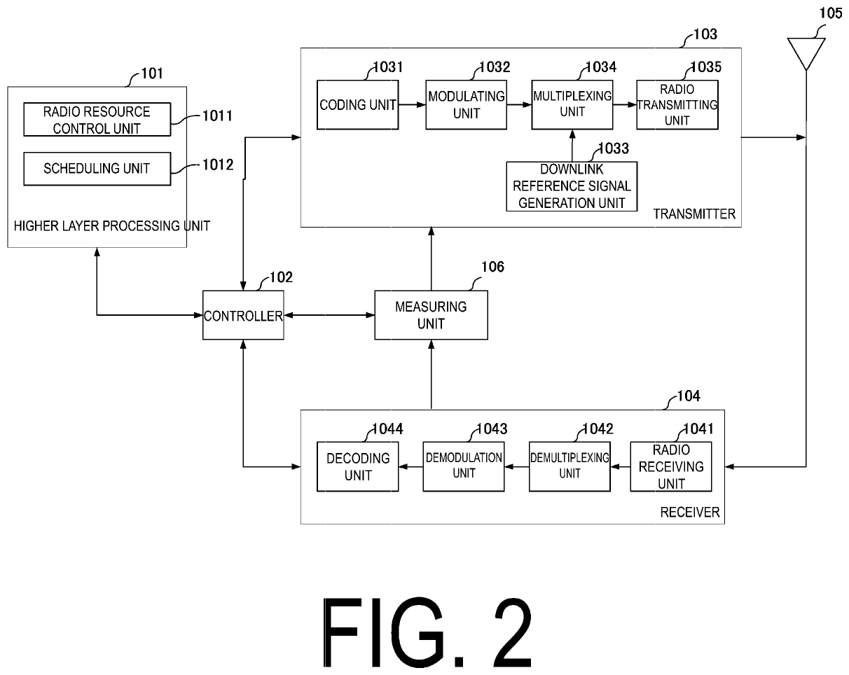

FIG. 2 is a schematic block diagram illustrating a configuration of the base station apparatus according to the present embodiment. As illustrated in FIG. 2, the base station apparatus includes a higher layer processing unit (higher layer processing step) 101, a controller (controlling step) 102, a transmitter (transmitting step) 103, a receiver (receiving step) 104, a transmit and/or receive antenna 105, and a measuring unit (measuring step) 106. The higher layer processing unit 101 includes a radio resource control unit (radio resource controlling step) 1011 and a scheduling unit (scheduling step) 1012. The transmitter 103 includes a coding unit (coding step) 1031, a modulation unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 includes a radio receiving unit (radio receiving step) 1041,. a demultiplexing unit (demultiplexing step) 1042, a demodulation unit (demodulating step) 1043, and a decoding unit (decoding step) 1044.

The higher layer processing unit 101 performs processing of a Medium Access Control (MAC) layer, a Packet Data Convergence Protocol (PDCP) layer, a Radio Link Control (RLC) layer, and a Radio Resource Control (RRC) layer. Furthermore, the higher layer processing unit 101 generates information necessary for control of the transmitter 103 and the receiver 104, and outputs the generated information to the controller 102.

The higher layer processing unit 101 receives information of a terminal apparatus, such as a capability of the terminal apparatus (UE capability), from the terminal apparatus. To rephrase, the terminal apparatus transmits its function to the base station apparatus by higher layer signaling.

Note that in the following description, information of a terminal apparatus includes information for indicating whether the terminal apparatus supports a presented function, or information for indicating that the terminal apparatus has completed the introduction and test of a prescribed function. In the following description, information of whether the prescribed function is supported includes information of whether the introduction and test of the prescribed function have been completed.

For example, in a case where a terminal apparatus supports a prescribed function, the terminal apparatus transmits information (parameters) for indicating whether the prescribed function is supported. In a case where a terminal apparatus does not support a prescribed function, the terminal apparatus does not transmit information (parameters) for indicating whether the prescribed function is supported. In other words, whether the predetermined function is supported is notified by whether information (parameters) for indicating whether the predetermined function is supported is transmitted. The information (parameters) for indicating whether the predetermined function is supported may be notified by using one bit of 1 or 0.

The radio resource control unit 1011 generates, or acquires from a higher node, the downlink data (the transport block) allocated in the downlink PDSCH, system information, the RRC message, the MAC Control Element (CE), and the like. The radio resource control unit 1011 outputs the downlink data to the transmitter 103, and outputs other information to the controller 102. Furthermore, the radio resource control unit 1011 manages various configuration information of the terminal apparatuses.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the controller 102.

The scheduling unit 1012 generates information to be used for scheduling the physical channels (PDSCH and PUSCH), based on the result of the scheduling. The scheduling unit 1012 outputs the generated information to the controller 102.

Based on the information input from the higher layer processing unit 101, the controller 102 generates a control signal for controlling the transmitter 103 and the receiver 104. The controller 102 generates the downlink control information based on the information input from the higher layer processing unit 101, and outputs the generated information to the transmitter 103.

The transmitter 103 generates the downlink reference signal in accordance with the control signal input from the controller 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2A through the transmit and/or receive antenna 105.

The coding unit 1031 codes the HARQ indicator, the downlink control information, and the downlink data that are input from the higher layer processing unit 101, in compliance with a prescribed coding scheme, such as block coding, convolutional coding, and turbo coding. Low density parity check coding (LDPC), or Polar coding, or in compliance with a coding scheme determined by the radio resource control unit 1011. The modulation unit 1032 modulates the coded bits input from the coding unit 1031, in compliance with the modulation scheme prescribed in advance, such as Binary Phase Shill Keying (BPSK), quadrature Phase Shift Keying (QPSK), quadrature amplitude modulation (16 QAM), 64 QAM, or 256 QAM, or in compliance with the modulation scheme determined by the radio resource control unit 1011.

The downlink reference signal generation unit 1033 generates, as the downlink reference signal, a sequence, known to the terminal apparatus 2A, that is determined in accordance with a rule predetermined based on the physical cell identity (PCI, cell ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to the resource elements.

The radio Transmitter 1035 performs Inverse Fast Fourier Transform (IFFT) on the modulation symbol resulting from the multiplexing or the like to generate an OFDM symbol, adds a cyclic prefix (CP) to the generated OFDM symbol to generate a baseband digital signal, converts the baseband digital signal into an analog signal, removes unnecessary frequency components through filtering, up-converts a result of the removal into a signal of a carrier frequency, performs power amplification, and outputs a final result to the transmit and/or receive antenna 105 for transmission.

In accordance with the control signal input from the controller 102, the receiver 104 demultiplexes, demodulates, and decodes the reception signal received from the terminal apparatus 2A through the transmit and/or receive antenna 105, and outputs information resulting from the decoding to the higher layer processing unit 101.

The radio receiving unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, anti converts the resulting orthogonally-demodulated analog signal into a digital signal.

The radio receiving unit 1041 removes a portion corresponding to CP from the digital signal resulting from the conversion. The radio receiving unit 1041 performs Fast Fourier Transform (FFT) of the signal from which the CP has been removed, extracts a signal in the frequency domain, and outputs the resulting signal to the demultiplexing unit 1042.

The demultiplexing unit 1042 demultiplexes the signal input from the radio receiving unit 1041 into signals such as PUCCH, PUSCH, and uplink reference signal. The demultiplexing is performed based on radio resource allocation information, included in the uplink grant predetermined by the base station apparatus 1A by using the radio resource control unit 1011 and notified to each of the terminal apparatuses 2A.

Furthermore, the demultiplexing unit 1042 performs channel compensation for PUCCH and PUSCH. The demultiplexing unit 1042 demultiplexes the uplink reference signal.

The demodulation unit 1043 performs Inverse Discrete Fourier Transform (IDFT) of PUSCH, obtains modulation symbols, and demodulates, for each of the modulation symbols of PUCCH and PUSCH, a reception signal in compliance with a prescribed modulation scheme, such as BPSK, QPSK, 16 QAM, 64 QAM, and 256 QAM, or in compliance with a modulation scheme that the base station apparatus 1A notified to each of the terminal apparatuses 2A in advance by using the uplink grant.

The decoding unit 1044 decodes the coded bits of PUCCH and PUSCH that have been demodulated, at a coding rate, in compliance with a prescribed coding scheme, that is prescribed or notified from the base station apparatus 1A to the terminal apparatus 2A in advance by using the uplink grant, and outputs the decoded uplink data and uplink control information to the higher layer processing unit 101. In a case where PUSCH is retransmitted, the decoding unit 1044 performs the decoding by using the coded bits that is input from the higher layer processing unit 101 and retained in art HARQ buffer, and the demodulated coded bits.

The measuring unit 106 observes the received signal, and determines various measurement values such as RSRP/RSRQ/RSSI. The measuring unit 106 determines received power, reception quality, and a preferable SRS resource index from the SRS transmitted from the terminal apparatus.

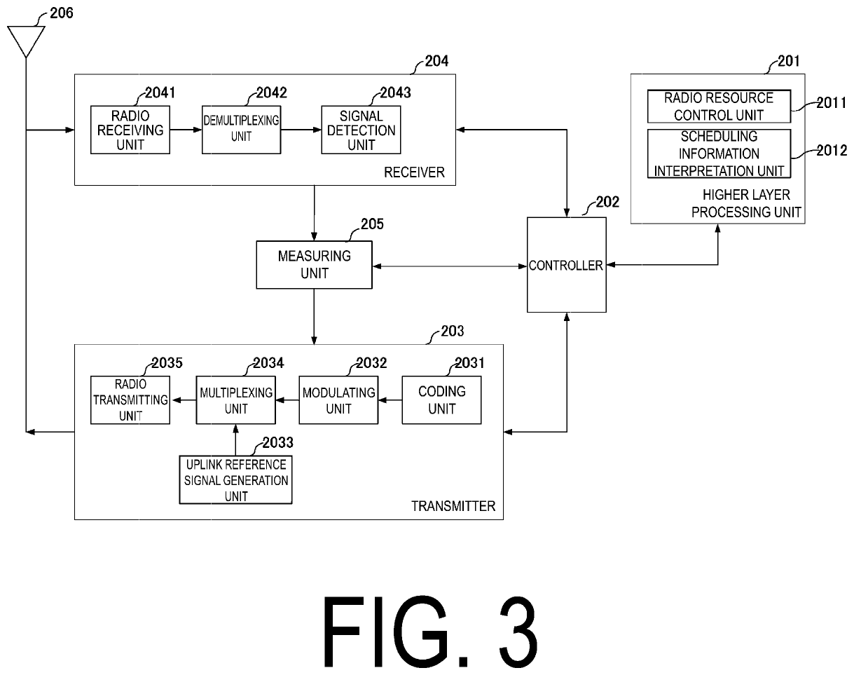

FIG. 3 is a schematic block diagram illustrating a configuration of the terminal apparat us according to the present embodiment. As illustrated in FIG. 3, the terminal apparatus includes a higher layer processing unit (higher layer processing step) 201, a controller (controlling step) 202, a transmitter (transmitting step) 203, a receiver (receiving step) 204, a measuring unit (measuring step) 205, and a transmit and/or receive antenna 206. The higher layer processing unit 201 includes a radio resource control unit (radio resource controlling stop) 2011 and a scheduling information interpretation unit (scheduling information interpreting step) 2012. The transmitter 203 includes a coding unit (coding step) 2031, a modulation unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 includes a radio receiving unit (radio receiving step) 2041, a demultiplexing unit (demultiplexing step) 2042, and a signal detection unit (signal detecting step) 2043.

The higher layer processing unit 201 outputs, to the transmitter 203, the uplink data (the transport block) generated by a user operation or the like. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmitter 203, information for indicating a terminal apparatus function supported by the terminal apparatus 2A.

Furthermore, the radio resource control unit 2011 manages various configuration information of the terminal apparatuses 2A. Furthermore, the radio resource control unit 2011 generates information to be mapped to each uplink channel, and outputs the generated information to the transmitter 203.

The radio resource control unit 2011 acquires configuration information transmitted from the base station apparatus, and outputs the acquired information to the controller 202.

The scheduling information interpretation unit 2012 interprets the downlink control information received through the receiver 204, and determines scheduling information. The scheduling information interpretation unit 2012 generates control information in order to control the receiver 204 and the transmitter 203 in accordance with the scheduling information, and outputs the generated information to the controller 202.

Based on the information input from the higher layer processing unit 201, the controller 202 generates a control signal for controlling the receiver 204, the measuring unit 205, and the transmitter 203. The controller 202 outputs the generated control signal to the receiver 204, the measuring unit 205, and the transmitter 203 to control the receiver 204 and the transmitter 203.

The controller 202 controls the transmitter 203 to transmit CSI/RSRP/RSRQ/RSSI generated by the measuring unit 205 to the base station apparatus.

In accordance with the control signal input from the controller 202, the receiver 204 demultiplexes, demodulates, and decodes a reception signal received from the base station apparatus through the transmit and/or receive antenna 206, and outputs the resulting information to the higher layer processing unit 201.

The radio receiving unit 2041 converts, by down-converting, a downlink signal received through the transmit and/or receive antenna 206 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 2041 removes a portion corresponding to CP from the digital signal resulting from the conversion, performs fast Fourier transform of the signal from which the CP has been removed, and extracts a signal in the frequency domain.

The demultiplexing unit 2042 demultiplexes the extracted signal into PHICH, PDCCH, EPDCCH, PDSCH, and the downlink reference signal. Furthermore, the demultiplexing unit 2042 performs channel compensation for PHICH, PDCCH, and EPDCCH based on a channel estimation value of a desired signal obtained from channel measurement, detects downlink control information, and outputs the detected downlink control information to the controller 202. The controller 202 outputs PDSCH and the channel estimation value of the desired signal to the signal detection unit 2043.

The signal detection unit 2043, by using the PDSCH and the channel estimation value, demodulates and decodes a signal, and outputs the demodulated and decoded signal to the higher layer processing unit 201. In a case of canceling or suppressing the interference signal, the signal detection unit 2043 acquires the channel estimate value of the interference channel using parameters for the interference signal, and demodulates and decodes the PDSCH.

The measuring unit 205 performs various measurements such as CSI measurement. Radio Resource Management (RRM) measurement. Radio Link Monitoring (RLM) measurement, and the like, and determines CSI/RSRP/RSRQ/RSSI.

The transmitter 203 generates an uplink reference signal in accordance with the control signal input front the controller 202, codes and modulates the uplink data (the transport block) input from the higher layer processing unit 201, multiplexes PUCCH, PUSCH, and the generated uplink reference signal, and transmits a signal resulting from the multiplexing to the base station apparatus through the transmit and/or receive antenna 206.

The coding unit 2031 codes the uplink control information or uplink data input from the higher layer processing unit 201 in compliance with a coding scheme such as convolutional coding, block coding, turbo coding, LDPC coding, or Polar coding.

The modulation unit 2032 modulates the coded bits input from the coding unit 2031, in compliance with a modulation scheme, such as BPSK, QPSK, 16 QAM, or 64 QAM, that is notified by using the downlink control information, or in compliance with a modulation scheme predetermined for each channel.

The uplink reference signal generation unit 2033 generates a sequence determined according to a prescribed rule (formula), based on a physical cell identity (also referred to as a Physical Cell Identity (PCI), a cell ID, or the like) for identifying the base station apparatus, a bandwidth in which the uplink reference signal is allocated, a cyclic shift notified with the uplink grant, a parameter value for generation of a DMRS sequence, and the like.

The multiplexing turn 2034 multiplexes PUCCH and PUSCH signals and the generated uplink reference signal for each transmit antenna port. To be more specific, the multiplexing unit 2034 maps the PUCCH and PUSCH signals and the generated uplink reference signal to resource elements for each transmit antenna port.

The radio transmitter 2035 performs Inverse Fast Fourier Transform (IFFT) on a signal resulting from the multiplexing, performs the modulation of OFDM scheme to generate an OFDMA symbol adds CP to the generated OFDMA symbol to generate a baseband digital signal, converts the baseband digital signal into an analog signal, removes unnecessary frequency components, up-converts a result of the removal into a signal of a carrier frequency, performs power amplification, and outputs a final result to the transmit and/or receive antenna 206 for transmission.

Note that the terminal apparatus can perform modulation according to not only the OFDM A scheme but also the SC-FDMA scheme.

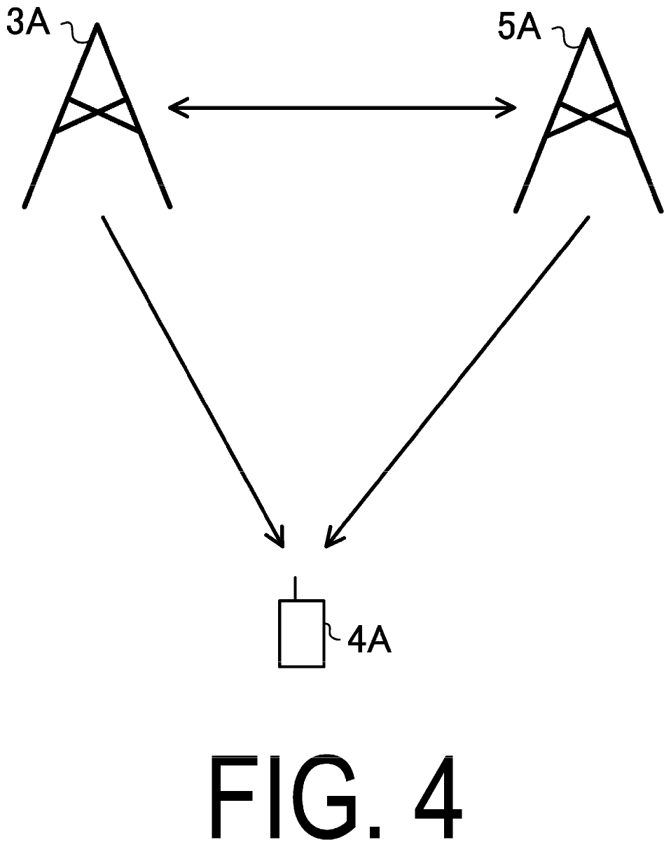

As a technique for increasing system throughput, Multiple Input Multiple Output (MIMO) transmissions are effective that multiplex multiple terminal apparatuses by spatial multiplexing. FIG. 4 is a diagram illustrating an example of a communication system according to the present embodiment The communication system illustrated in FIG. 4 includes a base station apparatus 3A and terminal apparatuses 4A and 4B. In a case that the base station apparatus 3A performs a multi-user MIMO transmission to the terminal apparatuses 4A and 4B. performance degradation may be caused by inter user interference. Note that the terminal apparatuses 4A and 4B are also simply referred to as the terminal apparatus.

In a case that ultra large-capacity communication is required, such as ultra high-definition video transmission, ultra wide band transmission utilizing high frequency bands is desired. Transmission in high frequency bands needs to compensate for path loss, and beamforming is important. In an environment in which multiple terminal apparatuses exist in a limited area, in a case that ultra large-capacity communication is required for each terminal apparatus, an Ultra-dense network is effective in which base station apparatuses are deployed at high density. However, in a case that the base station apparatuses are deployed at high density, the Signal to noise power ratio (SNR) is greatly improved, although strong interference due to beamforming may occur. Accordingly, realization of ultra large-capacity communication with every terminal apparatus in a limited area requires interference control (avoidance, suppression, and cancellation) in consideration of beamforming and/or coordinated communication among multiple base stations.

FIG. 5 illustrates an example of a downlink communication system according to the present embodiment, the communication system illustrated in FIG. 5 includes the base station apparatus 3A, the base station apparatus 5A, and the terminal apparatus 4A. The terminal apparatus 4A can use the base station apparatus 3A and/or the base station apparatus 5A as a serving cell. Additionally, in a case that the base station apparatus 3A or the base station apparatus 5A includes a multiplicity of antennas, the multiplicity of antennas can be divided into multiple subarrays (panels, subpannels, transmit antenna ports, a transmit antenna group, receive antenna ports, a receive antenna group), and transmit/receive beamforming can be applied to each of the subarrays. In this case, each subarray may include a communication apparatus, and the configuration of the communication apparatus is similar to the base station apparatus configuration illustrated in FIG. 2, unless otherwise indicated. In a case that the terminal apparatus 4A includes multiple antennas, the terminal apparatus 4A can perform transmission or reception through beamforming. In a case that the terminal apparatus 4A includes a multiplicity of antennas, the multiplicity of antennas can be divided into multiple subarrays (panels, subpannels, transmit antenna ports, a transmit antenna group, receive antenna ports, a receive antenna group), and different types of transmit/receive beamforming can be applied to the respective subarrays. Each subarray can include a communication apparatus, and the configuration of the communication apparatus is similar to the terminal apparatus configuration illustrated in FIG. 3, unless otherwise indicated. Note that the base station apparatus 3A and the base station apparatus 5A are also simply referred to its the base station apparatuses. Note that the terminal apparatus 4A is also simply referred to as the terminal apparatus.

The synchronization signal is used to determine a preferable transmit beam for the base station apparatus and a preferable receive beam for the terminal apparatus. The base station apparatus transmits synchronization signal blocks including PSS, PBCH, and SSS. Note that, in the synchronization signal block burst set period configured by the base station apparatus, one or multiple synchronization signal blocks are transmitted in the time domain, and a lime index is configured for each synchronization signal block. The terminal apparatus may consider that synchronization signal blocks with the same time index within a synchronization signal block burst set period have been transmitted from a somewhat quasi co-located (QCL) and can thus be considered to have the same delay spread, a Doppler spread, a Doppler shift, an average gain, an average delay, spatial reception parameters and/or spatial transmission parameters. Note that the spatial reception parameters (Rx parameters and a receive filter) include, for example, a spatial correlation between channels, an Angle of Arrival, a receive beam direction, and the like. Additionally, the spatial transmission parameters include, for example, a spatial correlation between channels, an Angle of Departure, a transmit beam direction, and the like. That is, the terminal apparatus can assume that synchronization signal blocks with the same time index within the synchronization signal block burst set period have been transmitted in the same transmit beam and that synchronization signal blocks with different time indexes have been transmitted in different beams. Accordingly, in a case that the terminal apparatus reports, to the base station apparatus, information indicating the time index of a preferable synchronization signal block in the synchronization signal block burst set period, the base station apparatus can recognize a transmit beam preferable for the terminal apparatus. The terminal apparatus can determine a preferable receive beam for the terminal apparatus by using synchronization signal blocks with the same time index in different synchronization signal block burst set periods. Thus, the terminal apparatus can associate the time index of the synchronization signal block with a receive beam direction and/or the subarray. Note that, in a case of including multiple subarrays, the terminal apparatus may use a different subarray to connect to a different cell. Note that the time index of the synchronization signal block is also referred to as an SSB index or an SSB Resource Indicator (SSBRI).

Four QCL types are available, indicating the states of QCL. The four QCL types are referred to as a QCL type A, a QCL type B, a QCL type C and a QCL type D, respectively. The QCL type A is a relationship (state) where the Doppler shift, Doppler spread, average delay, and delay spread are quasi co-located. The QCL type B is a relationship (state) where the Doppler shift and Doppler spread are quasi co-located. The QCL type C is a relationship (state) where the average delay and Doppler shift are quasi co-located. The QCL type D is a relationship (state) in which the spatial reception parameters are quasi co-located. Note that any of the four QCL types can be combined. For example, the QCL type A+QCL type D, the QCL type B+QCL type D. and the like are possible.

One or more TCI (Transmit Configuration Indicator) states are configured by higher layer signalling. One TCI state allows the QCL type of QCL with one or more downlink signals in a certain cell (cell ID) and in a certain partial band (BWP-ID). The downlink signals include a CSI-RS and an SSB. The TCI slate is, for example, included in the DCI and can be used, for example, to demodulate (decode) the associated PDSCH. Note that, in a case that the QCL type D is configured in the TCI state received in the DCL the terminal apparatus can recognize the receive beam direction of the associated PDSCH. Thus, the TCI can be said to be information related to the receive beam direction of the terminal apparatus.

The CSI-RS can be used to determine a preferable transmit beam for the base station apparatus and a preferable receive beam for the terminal apparatus.

The terminal apparatus receives the CSI-RS in a resource configured in accordance with the CSI resource configuration, calculates the CSI or RSRP from the CSI-RS, and reports the CSI or RSRP to the base station apparatus, In a case that the CSI-RS resource configuration includes multiple CSI-RS resource configurations, and/or in a case that the resource repetition is off, the terminal apparatus receives the CSI-RS in each CSI-RS source and in the same receive beam, and calculates the CRI. For example, in a case that the CSI-RS resource set configuration includes K (where K is an integer of 2 or greater) CSI-RS resource configurations, the CRI indicates preferable N CSI-RS resources included in K CSI-RS resources. In this case, N is a positive integer smaller than K. In a case that the terminal apparatus reports multiple CRIs, the terminal apparatus can report CSI-RSRP measured in each CSI-RS resource to the base station apparatus in order to indicate which CSI-RS resource has high quality. By beam forming (precoding) CSI-RS in different beam directions on the multiple CSI-RS resources configured, the base station apparatus can recognize the transmit beam direction of the base station apparatus preferable for the terminal apparatus from the CRI reported from the terminal apparatus. On the other hand, a preferable receive beam direction of the terminal apparatus can be determined using a CSI-RS resource to which the transmit beam for the base station apparatus is fixed. For example, in a case that the CSI-RS resource configuration includes multiple CSI-RS resource configurations and/or the resource repetition is on, the terminal apparatus can determine a preferable receive beam direction from the CSI-RS received in each different receive beam direction in each CSI-RS resource. Note that the terminal apparatus may report CSI-RSRP after determining the preferable receive beam direction. Note that in a case of including multiple subarrays, the terminal apparatus can select a preferable subarray in determining the preferable receive beam direction. Note that the preferable receive beam direction of the terminal apparatus may be associated with CRI, In a case that the terminal apparatus reports multiple pieces of CRI, the base station apparatus can fix the transmit beam to the CSI-RS resource associated with each piece of CRI, At this time, the terminal apparatus can determine the preferable receive beam direction for each piece of CRI. For example, the base station apparatus may associate a downlink signal/channel with the CRI for transmission. At this time, the terminal apparatus needs to use, for reception, a receive beam associated with the CRI. In the multiple CSI-RS resources configured, different base station apparatuses can transmit CSI-RSs. In this case, the network side can recognize, from the CRI, which base station apparatus provides high communication quality. In a case of including multiple subarrays, the terminal apparatus can perform reception at the multiple subarrays at the same timing. Accordingly, in a case that the base station apparatus uses downlink control information or the like to associate each of multiple layers (codewords or transport blocks) with the CRI for transmission, the terminal apparatus can receive multiple layers by using the subarray and receive beam corresponding to each piece of CRI. However, in a case that an analog beam is used and that one receive beam direction is used at one subarray at the same timing, the terminal apparatus may fail to receive multiple receive beams in a case that two pieces of CRI corresponding to one subarray of the terminal apparatus are simultaneously configured. To avoid this problem, for example, the base station apparatus groups the multiple CSI-RS resources configured, and determines the CRI by using the same subarray within the group. By using different subarrays among the groups, the base station apparatus can recognize multiple pieces of CR I that can be configured with the same timing. Note that a group of CSI-RS resources may include CSI-RS resources configured with the CSI resource configuration or the CSI-RS resource set configuration. Note that QCL may be assumed for pieces of CRI that can be configured with the same timing. At this time, the terminal apparatus can transmit the CRI in association with QCL information. The QCL information is information related to QCL for a prescribed antenna port, a prescribed signal, or a prescribed channel. In a case that long term performance of a channel on which a symbol on an antenna port is carried can be estimated from a channel on which a symbol on another antenna port is carried, the two antenna ports are said to be quasi co-located (in a QCL state). The long-term performance includes a delay spread, a Doppler spread, a Doppler shift, an average gain, an average delay, spatial reception parameters and/or spatial transmission parameters. For example, in a case that two antenna pons are quasi co-located, the terminal apparatus can consider the two antenna ports to have the same long-term performance. For example, in a case that the terminal apparatus distinguishes, in reporting, CRIs quasi co-located in terms of the spatial reception parameters from CRIs non-quasi co-located in terms of the spatial reception parameters, the base station apparatus can avoid configuring CRIs quasi co-located in terms of the spatial reception parameters, with the same timing, while configuring CRIs non-quasi co-located in terms of the spatial reception parameters, with the same timing. The base station apparatus may request CSI for each subarray of the terminal apparatus. In this case, the terminal apparatus reports the CSI for each subarray. Note that, in a case of reporting multiple pieces of CRI to the base station apparatus, the terminal apparatus may exclusively report non-quasi-co-located CRI.

In order to determine the preferable transmit beam for the base station apparatus, a codebook is used in which candidates for a prescribed precoding (beamforming) matrix (vector) are defined. The base station apparatus transmits CSI-RS, and the terminal apparatus determines a precoding (beamforming) matrix in the code book to be a preferable precoding matrix, and reports the matrix to the base station apparatus as PMI. Thus, the base station apparatus can recognize the preferable transmit beam direction for the terminal apparatus. Note that the codebook includes precoding (beamforming) matrices for combination of antenna ports and precoding (beamforming) matrices for selection from the antenna ports. In a case that a codebook for selection from the antenna ports is used, the base station apparatus can use different transmit beam directions for the respective antenna ports. Accordingly, in a case that the terminal apparatus reports an antenna port preferable as PMI, the base station apparatus can recognize the preferable transmit beam direction. Note that the preferable receive beam for the terminal apparatus may be a receive beam direction associated with the CRI or the preferable receive beam direction may be determined again. In a case that the codebook for selection from the antenna ports is used, a receive beam direction in which CSI-RS is received is desirably received in a receive beam direction associated with the CRI in a case that the preferable receive beam direction for the terminal apparatus is the receive beam direction associated with the CRI. Note that even in a case of using the receive beam direction associated with the CRI, the terminal apparatus can associate PMI with the receive beam direction. In a case that the codebook for selection from the antenna ports is used, the antenna ports may be transmitted from different base station apparatuses (cells). In this case, in a case that the terminal apparatus reports PMI, the base station apparatus can recognize which base station apparatus (cell) achieves preferable communication quality. Note that in this case, it can be assumed that the antenna ports of different base station apparatuses (cells) are not quasi collocated.

For improved reliability and increased frequency efficiency, multiple base station apparatuses (transmission and/or reception points) can perform coordinated communication. Examples of coordinated communication of multiple base station apparatuses (transmission and/or reception points) include, for example, Dynamic Point Selection (DPS) in which the preferable base station apparatus (transmission and/or reception point) is dynamically switched, Joint Transmission (JT) in which multiple base station apparatuses (transmission and/or reception points) transmit data signals, and the like. In a case of communicating with multiple base station apparatuses, the terminal apparatus may communicate using multiple subarrays. For example, in a case that the terminal apparatus 4A can use the subarray 1 to communicate with the base station apparatus 3A and can use the subarray 2 to communicate with the base station apparatus 5A. In a case that the terminal apparatus cooperatively communicates with multiple base station apparatuses, the terminal apparatus may dynamically switch among multiple subarrays or transmit and/or receive multiple subarrays at the same timing. At this time, the terminal apparatus 4A and the base station apparatus 3A/5A desirably share information related to a subarray of the terminal apparatuses used for communication.

The terminal apparatus can include CSI configuration information in the CSI report. For example, the CSI configuration information may include information indicating subarrays. For example, the terminal apparatus may transmit a CSI report including CRIs and indexes indicating the subarrays. In this way, the base station apparatus can associate the transmit beam direction with the subarrays of terminal apparatuses. Alternatively, the terminal apparatus may transmit a CRI report including multiple CRIs. In this case, in a case that the specification is such that some of the multiple CRIs are associated with a subarray 1 and the remainder CRIs are associated with a subarray 2, the base station apparatus may associate an index indicating the subarray with the CRIs. The terminal apparatus can joint-code the CRIs and the index indicating the subarray to transmit the resultant CRI report in order to reduce control information. In this case, of the N (N is an integer of 2 or greater) bits indicating the CRI, one bit indicates subarray 1 or subarray 2 and the remaining bits indicate CRI. Note that, in a case of joint coding, one bit is used for the index indicating the subarray, so the number of bits that can represent the CRI is reduced. Thus, in a case that the terminal apparatus reports the CSIs including the index indicating the subarray and that the number of CSI-RS resources indicated by the CSI resource configuration is greater than the number that can represent the CRI, the terminal apparatus can determine the CRIs from some CSI-RS resources. Note that in a case that different CSI resource configurations require that the CSI be calculated by using different, subarrays, the base station apparatus can recognize the CSI for each subarray of terminals in a case that the terminal apparatus transmits CSI calculated by using different subarrays for different resource configuration IDs.

The CSI configuration information may include configuration information for the CSI measurement. For example, the configuration information for the CSI measurement may be a measurement link configuration or other configuration information. Accordingly, the terminal apparatus can associate the configuration information for the CSI measurement with the subarray and/or the receive beam direction. For example, given coordinated communication with two base station apparatuses (e.g., base station apparatuses 3A and 5A), several pieces of configuration information are desirably available. The configuration of the CSI-RS for channel measurement transmitted by the base station apparatus 3A is designated as a resource configuration 1, and the configuration of the CSI-RS for the channel measurement transmitted by the base station apparatus 5A is designated as a resource configuration 2. In this case, the configuration information 1 may correspond to the resource configuration 1, configuration information 2 may correspond to the resource configuration 2, and configuration information 3 may correspond to the resource configuration 1 and the resource configuration 2. Note that each piece of the configuration information may include a configuration of an interference measurement resource. In a case that the CSI measurement is performed based on the configuration information 1, the terminal apparatus can measure the CSI by using the CSI-RS transmitted from the base station apparatus 3A. In a case that the CSI measurement is performed based on the configuration information 2, the terminal apparatus can measure the CSI transmitted from the base station apparatus 5A. In a case that the CSI measurement is performed based on the configuration information 3, the terminal apparatus can measure the CSI by using the CSI-RSs transmitted from the base station apparatus 3A and the base station apparatus 5A. The terminal apparatus can associate the subarray and/or the receive beam direction used for the CSI measurement with each of the pieces of configuration information 1 to 3. Accordingly, the base station apparatus can indicate a preferable subarray and/or receive beam direction used by the terminal apparatus by indicating any of the pieces of configuration information 1 to 3. Note that in a case that the configuration information 3 is configured, the terminal apparatus determines the CSI for the resource configuration 1 and/or the CSI for the resource configuration 2. At this time, the terminal apparatus can associate the subarray and/or the receive beam direction for each of the resource configuration 1 and/or the resource configuration 2. The resource configuration 1 and/or the resource configuration 2 can be associated with a codeword (transport block). For example, the CSI for the resource configuration 1 may be the CSI of a codeword 1 (transport block 1), and the CSI for the resource configuration 2 may be the CSI of a codeword 2 (transport block 2). The terminal apparatus can also obtain one CSI in consideration of the resource configuration 1 and the resource configuration 2. However, even in a case that one piece of CSI is obtained, the terminal apparatus can associate the subarray and/or the receive beam direction with each of the resource configuration 1 and the resource configuration 2.

In a case that multiple resource configurations are configured (for example, in a case that the configuration information 3 described above is configured), the CSI configuration information may include information indicating whether the CSI includes one CRI or CRIs for each of the multiple resource configurations. In a case that the CSI includes one CRI, the CSI configuration information may include a resource configuration ID from which the CRI has been calculated. The CSI configuration information allows the base station apparatus to recognize on what assumption the terminal apparatus has calculated the CSI or which resource configuration has high reception quality.

The base station apparatus can transmit, to the terminal apparatus, a CSI request to request a CSI report. The CSI request can include whether to report CSI for one subarray or CSI for multiple subarrays. In this case, in a case of being requested to report the CSI for one subarray, the terminal apparatus transmits a CSI report not including the index indicating the subarray. In a case of being requested to report the CSI for multiple subarrays, the terminal apparatus transmits a CSI report including the index indicating the subarray. Note that, in a case that the base station apparatus requests the CSI report for one subarray, the base station apparatus can indicate the subarray for which the CSI is to be calculated by the terminal apparatus, by using the index indicating the subarray or the resource configuration ID. In this case, the terminal apparatus calculates the CSI by using the subarray indicated by the base station apparatus.

The base station apparatus can transmit a CSI request including configuration information for the CSI measurement. In a case that the CSI request includes the configuration information for the CSI measurement, the terminal apparatus obtains the CSI based on the configuration information for the CSI measurement. The terminal apparatus reports the CSI to the base station apparatus, but need not report configuration information for the CSI measurement.

The terminal apparatus and the base station apparatus according to the present embodiment can configure new virtual antenna ports in order to select a preferable subarray. The virtual antenna ports are each associated with a physical sub-array and/or a receive beam. The base station apparatus can notify the terminal apparatus of the virtual antenna ports, and the terminal apparatus can select a subarray for reception of the PDSCH. The virtual antenna ports can be configured with QCL The base station apparatus can notify the terminal apparatus of multiple virtual antenna ports. In a case that the notified virtual antenna ports are quasi co-located, the terminal apparatus can receive the associated PDSCH by using one subarray, and in a case that the notified virtual antenna ports are not quasi co-located, can receive the associated PDSCH by using two or multiple subarrays. The virtual antenna ports can each be associated with any one or more of a CSI-RS resource, a DMRS resource, and an SRS resource. By configuring the virtual antenna ports, the base station apparatus can configure a subarray for a case that the terminal apparatus sends the RS in any one or more of the CSI-RS resource, the DMRS resource, and the SRS resource.

In a case that multiple base station apparatuses cooperatively communicate, the terminal apparatus desirably uses, for reception, the subarray and/or receive beam direction preferable for the PDSCH transmitted by each base station apparatus. Thus, the base station apparatus transmits information for the terminal apparatus to use the preferable subarray and/or receive beam direction for reception. For example, the base station apparatus can include the CSI configuration information or information indicating the CSI configuration information, in the downlink control information for transmission. In a case of receiving the CSI configuration information, the terminal apparatus can use, for reception, the subarray and/or the receive beam direction associated with the CSI configuration information.

For example, the base station apparatus can transmit, as the CSI configuration information, information indicating the subarray and/or the receive beam direction. Note that the CSI configuration information may be transmitted in a prescribed DCI format. The information indicating the receive beam direction may be the time index of the CRI, PMI, and the synchronization signal block. The terminal apparatus can recognize the preferable subarray and/or the receive beam direction from the received DCI. Note that the information indicating the subarray is expressed in 1 bit or 2 bits. In a case that information indicating the subarray is indicated in one bit, the base station apparatus can indicate the subarray 1 or subarray 2 to the terminal apparatus as “0,” or “1.” In a case that information indicating the subarray is indicated in two bits, the base station apparatus may indicate the terminal apparatus to switch between subarrays and to use two subarrays for reception. Note that in a case that different resource configurations specify that the CSI be calculated in different subarrays, the base station apparatus may indicate the subarray of terminal apparatuses by including the resource configuration ID in the DCI for transmission.

For example, the base station apparatus can transmit configuration information for the CSI measurement as CSI configuration information. In this case, the terminal apparatus can receive the PDSCH by using the subarray and/or the receive beam direction associated with the CSI fed back in the configuration information for the CSI measurement received. Note that in a case that the configuration information for the CSI measurement indicates the configuration information 1 or the configuration information 2, the CSI configuration information indicates that the PDSCH transmission is associated with one piece of resource configuration information. In a case that the configuration information for the CSI measurement indicates the configuration information 3, the CSI configuration information indicates that the PDSCH transmission is associated with multiple pieces of resource configuration information.

The CSI configuration information may be associated with a parameter (field) included in the DCI, such as the DMRS Scrambling identity (SCID). For example, the base station apparatus may configure the association of the SCID and configuration information for the CSI measurement. In this case, the terminal apparatus can reference the configuration information for the CSI measurement based on the SCID included in the DCI, and can receive the PDSCH in the subarray and/or the receive beam direction associated with the configuration information for the CSI measurement.

The base station apparatus can also configure two DMRS antenna port groups. This two DMRS port groups are also referred to as a DMRS port group 1 (first DMRS port group), and a DMRS port group 2 (second DMRS port group). The antenna ports in the DMRS antenna port group are quasi co-located, and the antenna ports between the DMRS antenna port groups are not quasi co-located. Accordingly, in a case that the DMRS antenna port group and the subarray of terminal apparatuses are associated with each other, the base station apparatus can indicate the subarray of terminal apparatuses with a DMRS antenna port number included in the DCI. For example, in a case that the DMRS antenna port number included in the DCI is included in one DMRS antenna port group, the terminal apparatus uses, for reception, one subarray corresponding to the DMRS antenna port group. In a case that the DMRS antenna port number included in the DCI is included in both the two DMRS antenna port groups, the terminal apparatus uses two subarrays for reception. One DMRS antenna port group may be associated with one codeword (transport block). The relationship between the DMRS antenna port group and the index of the codeword (transport block) may be predetermined or may be indicated by the base station apparatus.

Note that in a case that different resource configurations specify that the CSI is calculated in different subarrays, as long as the DMRS antenna port group is associated with the resource configuration ID or CSI-RS resource, the DMRS antenna port included in the DCI enables the terminal apparatus to identify the resource configuration ID or the CSI-RS resource, and to recognize the subarray and/or the receive beam direction.

The base station apparatus can configure the DMRS antenna port group and CSI configuration information in association with each other. Note thru in a case that the CSI configuration information includes the configuration information for the CSI measurement and the configuration information for the CSI measurement indicates the configuration information 3, the terminal apparatus uses the subarray and/or receive beam direction corresponding to resource configuration 1 for demodulation in a case of the DMRS antenna port included in the DMRS antenna port group 1, and uses the subarray and/or receive beam direction corresponding to resource configuration 2 for demodulation in a case of the DMRS antenna port included in the DMRS antenna port group 2.

In a case that the CSI report configuration indicates the report quantity configured with CRI/RSRP or SSBRI/RSRP and group-based beam reporting configured OFF, the terminal apparatus reports one, two or four different CRIs or SSBRIs in one report. In a case that the CSI report configuration indicates the report quantity configured with CRI/RSRP or SSBRI/RSRP and group-based beam reporting configured ON, the terminal apparatus reports t wo different CRIs or SSBRIs in one report. However, the two CSI-RS resources or the two SSBs can be received simultaneously by a receive filter in one spatial region or receive filters in multiple spatial regions.

In a case that the CSI report configuration indicates the report quantity configured with the CRI, RI, and CQI and the group based beam reporting configured ON, the terminal apparatus determines the CSI based on two CSI-RS resources that, can be received simultaneously by a receive filter (panel, subarray) in one spatial region or receive filters (panels, subarrays) in multiple spatial regions. The two CSI-RS resources are referred to as a first CSI-RS resource and a second CSI-RS resource, respectively. The CRI indicating the first CSI-RS resource is also referred to as a first CRI, and a CRI indicating the second CSI-RS resource is also referred to as a second CRI. The RI determined by the first CSI-RS resource is also referred to as a first RI, and the RI determined by the second CSI-RS resource as a second RI Note that, in a case that the RI is 4 (4 layers) or less, the number of codewords is 1, and that in a case that the RI is greater than 4, the number of codewords is two. Accordingly, the CSI reported by the terminal apparatus may vary depending on whether the total of the first RI and the second RI is 4 or greater than 4. In a case that the total of the first RI and the second RI is 4 or less, the CQI determined in consideration of both the first CSI-RS and the second CSI-RS is determined. At this time, the terminal apparatus reports, as the CSI, the CQI determined in consideration of the first CRI, the second CRI, the first RI, the second RI, and both the first CSI-RS and the second CSI-RS as CSI. In a case where the total of the first RI and the second RI is greater than 4, the first CQI determined by the first CSI-RS and the second CQI determined by the second CSI-RS are determined. At this time, the terminal apparatus reports the first CRI, the second CRI, the first RI the second RI the first CQI, and the second CQI as CSI.

In a case that the CSI report configuration indicates the report quantity configured with the CRI, RI, PMI, and CQI and the group-based beam reporting configured ON, the terminal apparatus determines the CSI based on two CSI-RS resources that can be received simultaneously by a receive filter in one spatial region or receive filters in multiple spatial regions. The PMI for the first CSI-RS resource is also referred to as a first PMI, and the PMI for the second CSI-RS resource is also referred to as a second PMI. Note that the first PMI and the second PMI may be determined in consideration of both the first CRI and the second CRI. In this case, the first PMI and the second PMI are determined with mutual interferences taken into account. Note that PMI is divided into PMI-1 and PMI-2 in a case that the CSI-RS corresponds to four or more antenna ports. The PMI-1 is wideband information, and indicates a codebook index determined based at least based on the N1 and N2. Note that the number of antenna ports for the CSI-RS is represented by 2N1N2. Note that the N1 and N2 are both integers of 1 or greater and that N1 represents the number of antenna ports in a first dimension (e.g., horizontal direction) and that N2 represents the number of antenna ports in a second dimension (e.g., vertical direction). The number of polarizations antenna is 2. Moreover, the PMI-1 includes one or more pieces information depending on the values of the N1 and N2 and the RI (the number of layers). Moreover, the PMI-2 is wideband or sub-band information, and indicates at least phase rotation. Note that the PMI-1 and PMI-2 determined by the first CSI-RS resource are also respectively referred to as a first PMI-1 and a first PMI-2. Moreover, the PMI-1 and PMI-2 determined by the second CSI-RS resource are also respectively referred to as a second PMI-1 and a second PMI-2. Note that the report quantity may be configured with the CRI, RI, PMI-1, and CQI. Note that a case of the CRI, RI, and CQI is similar to a case where the report quantity is configured with the CRI, RI, and CQI. Consequently, in a case that the total of the first RI and the second RI is 4 or less, the terminal apparatus reports, as the CSI, the CQI determined in consideration of the first CRI, the second CRI, the first RI, the second RI, the first PMI (PMI-1), the second PMI (PMI-1), and both the first CSI-RS and the second CSI-RS as CSI. In a case that the total of the first RI and the second RI is greater than 4, the terminal apparatus reports, as the CSI, the first CRI, the second CRI, the first RI, the second RI, the first PMI (PMI-1), the second PMI (PMI-1), the first CQI, and the second CQI.

Note that, in a case that the total of the first RI and the second RI is greater than 4, the number of layers with a codeword number 1 is the same as or smaller than the number of layers with a codeword number 2. the first RI is the same as or smaller than the second RI. That is, in a case that the RI is reported, one of the first CRI and the second CRI having a higher received power (RSRP)/received qualify (RSRQ) is not the first CRI, the first CRI or the second CRI is determined by the value of the RI rather than the first CRI. In a case that the number of layers of the codeword 1 and the number of layers of the codeword 2 are different, the difference is 1. That is, in a case that the total of the first RI and the second RI is 5, the first RI is 2 and the second RI is 3. In a case that the total of the first RI and the second RI is 6, the first RI is 3 and the second RI is 3. In a case that the total of the first RI and the second RI is 7, the first RI is 3 and the second RI is 4. In a case that the total of the first RI and the second RI is 8, the first RI is 4 and the second RI is 4. In a case where the difference between the first RI and the second RI is greater than 1, the terminal apparatus may report the CSI of one of the first CRI or the second CRI, for example, the CRI with a greater RI. Because of the rule described above, the terminal apparatus may report the total value of the first RI and the second RI without reporting the first RI and the second RI separately. Note that in a case that the group-based beam reporting is configured ON and the report quantity is configured with the CRI, RI, CQI or CRI, RI, PMI (PMI-1), and CQI, the first CRI and the second CRI may have different codewords. At this time, for the CQI, the first CQI and the second CQI are reported. However, the total of the first RI and the second RI is 8 or less, and the RI in one CRI is 4 or less. Note that in a case that the first CRI and the second CRI have different codewords, the base station apparatus may indicate the codewords to the terminal apparatus. Note that, even in a case that the first CRI and the second CRI have different codewords, in a case that the number of layers of the codeword 1 and the number of layers of the codeword 2 are different, the difference may be 1. At this time, in a case that the total of the first RI and the second RI is 4, the first RI is 2 and the second RI is 2. In a case that the total of the first RI and the second RI is 3, the first RI is 1 and the second RI is 2. In a case that the total of the first RI and the second RI is 2, the first RI is 1 and the second RI is 1.

The priority of the CSI report is configured higher for the CRI with a greater RI. That is, in the present embodiment, the second CRI has a higher priority than the second CRI. For example, in a case that the amount of information of the PUCCH is insufficient, the RI/PMI/CQI determined by using the second CRI and the second CRI is reported, and the RI/PMI/CQI determined by using the first CRI and the first CRI are dropped. Note that, in a case that the CQI is reported by one of the CRIs, the CQI determined by the one CRI is reported even in a case that the total of the first RI and the second RI is 4 or less.

In a case that the CSI is reported in the PUSCH or the subband CSI is reported in the PUCCH, the reported CSI is divided into two parts. The two parts are also referred to as a first part (part 1 or CSI part 1), and a second part (part 2 or CSI part 2). Note that the first part has a higher priority in CSI report than the second part. For example, in a case that the RI is 4 or less, the first part includes some or all of the total of the first RI and the second RI (or second RI), the second CRI, or the CQI based on the first CRI and the second CRI (or the second CQI). The second part includes some or all of the first CRI, the first RI the first CQI the first PMI, and the second PMI. In a case that the RI is greater than 4, the first part includes some or all of the total of the first RI and the second RI (or second RI), the second CRI and the second CQI. The second part includes some or all of the first CRI, the first RI, the first CQI, the first PMI, and the second PMI. Note that the CSI may be divided into three parts. The third part is also referred to as the third part (part 3 or CSI part 3). The third part has a lower priority than the second part. At this time, the first part includes some or all of the total of the first RI and the second RI (or second RI), the second CRI the CQI based on the first CRI and the second CRI (or second CQI). The second part includes some or all of the first CRI, the first RI the first CQI. The third part includes some or all of the first PMI and the second PMI.

Note that the terminal apparatus may divide each of the CSI based on the first CRI and the CSI based on the second CRI into two parts for reporting. Note that the two parts of the CSI based on the first CRI are also referred to as a first part 1 and a first part 2. Two parts of the CSI based on the second CRI are also referred to as a second part 1 and a second part 2. Note that the first part 1 includes some or all of the first CRI, the first RI, and the first CQI. The first part 2 also includes the first PMI. The second part 1 includes some or all of the second CRT the second RI, the second CQI. The second part 2 includes the second PMI, the Note that the priority of CSI can be configured to increase in order of the second part 1, the first part 1, the second part 2, and the first part 2. At this time, the terminal apparatus reports CSI with a long periodicity (few changes) by using the second CRI and the first CRI, and the base station apparatus and the terminal apparatus can communicate using the minimum parameters related to the first CRI and the second CRI. The priority of CSI can be configured to increase in order of the second part 1, the second part 2, the first part 1, and the first part 2. At this time, with the terminal apparatus preferentially reporting the complete CSI for the second CRI, the base station apparatus and the terminal apparatus can communicate by using detailed parameters related to the second CRI.

Note that in a case that the first RI and the second RI are 4 or less and the first CRI and the second CRI have separate codewords, the terminal apparatus reports information indicating that both or one of the CSI based on the first CRI and the CSI based on the second CRI. Note that the information indicating that both the CSI based on the first CRI and the CSI based on the second CRI are reported is included in the first part of the CSI. Note that information indicating that both or one of the CSI based on the first CRI and the CSI based on the second CRI is reported may indicate whether or not the first CRI is included in the second part of the CSI.

For the DMRS for the PDSCH or the PUSCH, a DMRS configuration type 1 (first DMRS configuration type) or a DMRS configuration type 2 (second DMRS configuration type) are configured. The DMRS configuration type 1 corresponds to up to eight DMRS antenna ports, and the DMRS configuration type 2 corresponds to up 12 DMRS antenna ports. Additionally, the DMRS is code-division-multiplexed (CDM) by an Orthogonal Cover Code (OCC). The OCC has a code length of tip to 4 and has a length 2 in the frequency direction and a length of 2 in the time direction. A front-loaded DMRS is allocated at one symbol or two symbols. In a case that the front-loaded DMRS is allocated at one symbol, the DMRS fails to be multiplexed in the time direction, resulting in only multiplexing in the frequency direction. This case may be represented as OCC=2. The OCC is used to CDM up to four DMRS antenna ports. Note that the four DMRS antenna ports CDMed are also referred to as a CDM group (DMRS CDM group). In this case, a DMRS configuration type 1 includes two CDM groups, and a DMRS configuration type 2 includes three CDM groups. The DMRSs of different CDM groups are allocated to orthogonal resources. Note that the two CDM groups of the DMRS configuration type 1 are also referred to as a CDM group 0 (first CDM group) and a CDM group 1 (second CDM group). Three COM groups of DMRS configuration type 2 are also referred to as a CDM group 0 (first CDM group), a CDM group 1 (second CDM group), and a CDM group 2 (third CDM group). For the DMRS configuration type 1, the CDM group 0 includes DMRS antenna ports 1000, 1001, 1004, and 1005 and the CDM group 1 includes DMRS antenna ports 1002, 1003, 1006, and 1007. For the DMRS configuration type 2, the CDM group 0 includes DMRS antenna ports 1000, 1001, 1006, and 1007, the CDM group 1 includes DMRS antenna ports 1002, 1003, 1008, and 1009, and the CDM group 2 includes DMRS antenna polls 1004, 1005, 1010, and 1011. Note that the CDM group associated with the DMRS is also referred to as a DMRS CDM group.

Additionally, the DMRS antenna port number for the PDSCH or PUSCH and the number of DMRS CDM groups with no data are indicated in the DCI. The terminal apparatus can recognize the number of DMRS antenna pons by the number of indicated DMRS antenna port numbers. The number of DMRS CDM groups with no data indicates that no PDSCH is allocated to resources to which the DMRSs of the associated CDM group are allocated. Note that, in a case that the number of DMRS CDM groups with no data is 1, the CDM group referenced includes a CDM group 0 and that, in a case that the number of DMRS CDM groups with no data is 2, the CDM group referenced includes the CDM group 0 and a CDM group 1 and that, in a case that the number of DMRS CDM groups with no data is 3, the CDM group referenced includes the CDM group 0, the CDM group 1, and CDM group 2.

Note that, for example, in a case of transmission of Multi User-Multiple Input Multiple Output (MU-MIMO), the DMRS for the PDSCH or PUSCH can be different in power from the PDSCH. For example, it is assumed that the base station apparatus spatial multiplexes the PDSCH with four layers and transmits the resultant PDSCH to each of the two terminal apparatuses. In other words, the base station apparatus obtains, by spatial multiplexing, the PDSCH with a total of eight layers and transmits the resultant PDSCH. In this case, the base station apparatus indicates the DMRS antenna port numbers of the CDM group 0 to one of the terminal apparatuses, and the DMRS antenna port numbers of the CDM group 1 to the other terminal apparatus. The base station apparatus indicates the number of DMRS CDM groups with no data the two terminal apparatuses as 2. At this time, the spatial multiplexing number of the DMRS is 4, whereas the spatial multiplexing number of the PDSCH is 8, and the power ratio (offset) between the DMRS and the PDSCH is 2 (different by 3 dB). For example, it is assumed that the base station apparatus spatially multiplexes the PDSCH with four layers and transmits the resultant PDSCH to each of the three terminal apparatuses. In other words, the base station apparatus obtains, by space multiplexing, the PDSCH with a total of 12 layers, and transmits the resultant PDSCH. In this case, the base station apparatus respectively indicates the DMRS antenna port numbers of the CDM group 0, the CDM group 1, and the CDM group 2 to the three terminal apparatuses. The base station apparatus indicates the number of DMRS CDM groups with no data to the three terminal apparatuses as 3. At this time, the spatial multiplexing number of the OMRS is 4, whereas the spatial multiplexing number of the PDSCH is 12, and the power ratio between the DMRS and the PDSCH is 3 (different by 4.77 dB). Accordingly, the base station apparatus or the terminal apparatus transmits the DMRS and PDSCH in consideration of the power ratio between the DMRS and the PDSCH multiplied by the number of CDM groups. The base station apparatus or the terminal apparatus demodulate (decode) the PDSCH in consideration of the power ratio between the DMRS and the PDSCH multiplied by the number of CDM groups. Note that, also for a SU-MIMO (Single user MIMO) transmission with a large spatial multiplexing number, the power ratio between the DMRS and the PDSCH multiplied by the number of CDM groups is taken into account.

However, in a case that the terminal apparatus communicates with multiple base station apparatuses (transmission and/or reception points), the power ratio between the DMRS and the PDSCH may be different from those described above. For example, it is assumed that, in a case that the terminal apparatus communicates with two base station apparatuses (transmission and/or reception points), each of the base station apparatuses transmits four layers of PDSCH resulting from spatial multiplexing. In this case, the number of DMRS CDM groups with no data is indicated as 2 from one or both of the base station apparatuses. However, because the spatial multiplexing number of the DMRS and the spatial multiplexing number of the PDSCH transmitted from each of the base station apparatuses are 4, the power ratio between the DMRS and the PDSCH is 1 (0 dB), and the power ratio between the DMRS and the PDSCH need not be considered. Accordingly, the terminal apparatus needs to recognize (determine) whether or not to demodulate (decode) the PDSCH in consideration of the power ratio between the DMRS and the PDSCH. Note that, in a case that the terminal apparatus communicates with multiple base station apparatuses (transmission and/or reception points), each of the base station apparatuses (transmission and/or reception points) may reduce the power of the PDSCH according to the number of DMRS CDM groups with no data and transmit the PDSCH with reduced power. However, this degrades reliability and reduces the throughput.

The base station apparatus can transmit, to the terminal apparatus, the power ratio between the DMRS and the PDSCH or information indicating whether or not to demodulate (decode) the PDSCH in consideration of the power ratio between the DMRS and the PDSCH. In this case, the terminal apparatus can demodulate (decode) the PDSCH in accordance with the received power ratio between the DMRS and the PDSCH or information indicating whether or not to demodulate (decode) the PDSCH in consideration of the power ratio between the DMRS and the PDSCH.

The terminal apparatus can determine the power ratio between the DMRS and the PDSCH from the configuration of the DMRS port group. For example, it is assumed that, in the DMRS configuration type 1, the DMRS port group 1 is configured (associated) with the COM group 0, specifically, the DMRS ports 1000, 1001, 1004, and 1005, and that the DMRS port group 2 is configured (associated) with the CDM group 1, specifically, the DMRS port 1002, 1003, 1006, and 1007. At this time, in a case that the DMRS antenna port numbers configured in the two DMRS port groups are indicated in the DCI, the terminal apparatus demodulates (decodes) the PDSCH on the assumption that the power ratio between the DMRS and the PDSCH is 1 (0 dB) even though the number of DMRS CDM groups with no data is indicated as 2. In a case that the DMRS antenna port, numbers configured only in one DMRS port group are indicated in the DCI, the terminal apparatus demodulates (decodes) the PDSCH on the assumption that the power ratio between the DMRS and the PDSCH is 1 (0 dB).

The terminal apparatus can determine the power ratio between the DMRS and the PDSCH based on the TCI. In a case that the received TCI indicates a configuration for the two DMRS port groups, the terminal apparatus demodulates (decodes) the PDSCH on the assumption that the power ratio between the DMRS and the PDSCH is 1 (0 dB) even in a case that the number of DMRS CDM group number with no data is 2 or 3. Otherwise, the terminal apparatus determines the power ratio between the DMRS and the PDSCH according to the number of DMRS CDM groups with no data.

The initial value of the DMRS sequence is calculated based on at least an NID and the SCID. At most two SCIDs are configured and indicated as 0 or 1. The NID is associated with the SCID and is configured by higher layer signalling. For example, the NID for SCID=0 and the NID for SCID=1 are configured. In a case that the NID or SCID is not configured, the SCID=0 and the NID is a physical cell ID. The SCID is included in the DCI. Additionally, the SCID may indicate whether or not to demodulate (decode) the PDSCH in consideration of the power ratio of the DMRS and the PDSCH. For example, for SCID=0, the terminal apparatus demodulates (decodes) the PDSCH in consideration of the power ratio between the DMRS and the PDSCH according to the DMRS CDM group number with no data, and for SCID=1, the terminal apparatus demodulates (decodes) the PDSCH without considering the power ratio between the DMRS and the PDSCH. The SCID may be associated with the DMRS port group. For example, the DMRS associated with the DMRS port group 1 is generated in a sequence at SCID=0, and the DMRS associated with the DMRS port group 2 generates a sequence with SCID=1.

Note that in a case that multiple base station apparatuses (transmission and/or reception points) communicate with a terminal apparatus and that each of the base station apparatuses transmits the PDCCH to the terminal apparatus in the same slot, the base station apparatuses can space-multiplex the different terminal apparatuses by MU-MIMO. For example, it is assumed that the base station apparatus 3A transmits the PDCCH1 (DCI1) to the terminal apparatus 4A and that the base station apparatus 5A transmits the PDCCH2 (DCI2) to the terminal apparatus 4A. Note that the PDCCH1 and the PDCCH2 are transmitted in the same slot. Although not illustrated, it is assumed that the base station apparatus 5A spatially multiplexes the terminal apparatus 4A and the terminal apparatus 4B. The DMRS configuration type 2 is assumed, and it is assumed that the base station apparatus 3A configures, for the terminal apparatus 4A, the DMRS port 1000, 1001, 1006, and 1007 as the DMRS port group 1, and configures the DMRS port 1002, 1003, 1008, and 1009 as the DMRS port group 2. The DMRS port numbers included in the DCI1 are 1000, 1001, 1006, and 1007, and the number of CDM groups with no data is 2. Additionally, the DMRS port numbers included in the DCI1 are 1002, 1003, 1008, and 1009, and the number of CDM groups with no data is 3. At this time, the base station apparatus 5A communicates with the terminal apparatus 4B using the DMRS port numbers 1004, 1005, 1010, and 1011. At this time, the terminal apparatus 4A recognizes, in the DCI1, the DMRS of the DMRS port group 1, and in the DCI2, the DMRS of the DMRS port group 2. Consequently, because the two DMRS CDM group with no data indicated in the DCI1 are used for transmission addressed to the terminal apparatus 4A, the terminal apparatus 4A can determine the power ratio between the DMRS DMRS ports 1000, 1001, 1006, and 1007 indicated by the DCI1 and the corresponding PDSCH to be 1 (0 dB). Two of the three CDM groups with no data indicated in the DCI2 are used for the transmission addressed to the terminal apparatus 4A, the terminal apparatus 4A can determine the power ratio between the DMRS ports 1002, 1003, 1008, and 1009 indicated in the DCI2 and the corresponding PDSCH to be 2 (3 dB). In other words, in a case of receiving two PDCCHs in the same slot, the terminal apparatus can determine the power ratio between the DMRS and the PDSCH by considering the number obtained by subtracting 1 from the number of DMRS CDM groups with no data indicated in one of the two types of DCI.

The terminal apparatus may receive inter-user interference from a serving cell and an interference signal from neighbor cells. The terminal apparatus can improve reliability and throughput by removing or suppressing the interference signal. In order to remove or suppress the interference signal, parameters for the interference signal are required. The interference signal is the PDSCH, PDCCH, or reference signal addressed to the neighbor cell/another terminal apparatus. As schemes for canceling or suppressing interference signal, Enhanced-Minimum Mean Square Error (E-MMSE) which estimates the channel of the interference signal and is suppressed by the linear weight, an interference canceler that generates and removes an interference signal replica, a Maximum Likelihood Detection (MLD) for detecting a desired signal, in which all of the desired signal and the interference signal transmit signal candidate are searched, a Reduced complexity-MLD (R-MLD) with a lower computation amount than the MLD by reducing transmit signal candidates, and the like can be applied. Application of these schemes requires channel estimation for the interference signal, demodulation of the interference signal, or decoding of the interference signal.

Thus, in order to efficiently remove or suppress the interference signal, the terminal apparatus needs to recognize the parameters for the interference signal (neighbor cell). Thus, the base station apparatus can transmit (configure) assistance information including the parameters for the interference signal (neighbor cell) to the terminal apparatus to assist the terminal apparatus in canceling or suppressing the interference signal. One or multiple pieces of assistance information are configured. The assistance information includes, for example, some or all of the physical cell ID, the virtual cell ID, the power ratio (power offset) between the reference signal and the PDSCH, the scrambling identity of the reference signal, the quasi co-location (QCL) information, the CSI-RS resource configuration, the number of CSI-RS antenna ports, the subcarrier spacing, a resource allocation granularity, resource allocation information, a Bandwidth Part Size configuration, the DMRS configuration, the DMRS antenna port number, the number of layers, a TDD DL/UL configuration, the PMI, the RI, the modulation scheme, the Modulation and coding scheme (MCS), the TCI state, and the PT-RS. Note that the virtual cell ID is an ID virtually allocated to the cell and that cells may have the same physical cell ID and different virtual cell IDs. The QCL information is information related to QCL for a prescribed antenna port, a prescribed signal, or a prescribed channel. The subcarrier spacing indicates the subcarrier spacing of the interference signal or candidates for a subcarrier spacing that may be used in the band. Note that, in a case that the subcarrier spacing included in the assistance information differs from a subcarrier spacing used in communication with a serving cell, the terminal apparatus need not cancel or suppress the interference signal. The candidates for the subcarrier spacing that may be used in the band may indicate commonly used subcarrier spacings. For example, the commonly used subcarrier spacings need not include a low-frequency subcarrier spacing as used for high reliability, low latency communication (emergency communication). The resource allocation granularity indicates the number of resource blocks for which precoding (beamforming) remains unchanged. The DMRS configuration indicates some or all of the information indicating a PDSCH mapping type, an additional allocation of the DMRSs, the power ratio between the DMRS and the PDSCH, the DMRS configuration type, the number of symbols for the front-loaded DMRSs, and the information indicating OCC=2 or 4. The DMRS resource allocation varies depending on the PDSCH mapping type. For example, in a PDSCH mapping type A, DMRS is mapped to the third symbol in a slot. For example, in a PDSCH mapping type B, DMRS is mapped to the first OFDM symbol in an allocated PDSCH resource. The additional mapping of DMRS indicates whether to additionally map DMRS or not or additional mapping. The PT-RS information includes some or all of the presence (presence or absence; of the PT-RS, the number of ports for the PT-RS, the time density, the frequency density, the resource allocation information, the associated DMRS ports (DMRS port group), and the power ratio between the PT-RS and the PDSCH. Note that some or all of the parameters included in the assistance information are transmitted (configured) through the higher layer signalling. Some or all of the parameters included in the assistance information are transmitted in the downlink control information. In a case that each of the parameters included in the assistance information indicates multiple candidates the terminal apparatus blind-detects a preferable one of the candidates. Parameters not included in the assistance information are blind-detected by the terminal apparatus.

In a case that the terminal apparatus communicates using multiple receive beam directions, ambient interference conditions vary greatly depending on the receive beam direction. For example, an interference signal that is strong in one receive beam direction may be weaker in another receive beam direction. Not only may the assistance information for a cell that is unlikely to interfere significantly be meaningless, but may also lead to wasteful computations in a case that whether a strong interference signal is being received or not is determined. Accordingly, the assistance information is desirably configured for each receive beam direction. However, the base station apparatus does not necessarily recognize the reception direction for the terminal apparatus, and thus information related to the receive beam direction may be associated with the assistance information. For example, the terminal apparatus can associate the CRI with the receive beam direction, and thus the base station apparatus can transmit (configure) one or multiple pieces of assistance information for each piece of the CRI. The terminal apparatus can associate the time index of the synchronization signal block with the receive beam direction, and thus the base station apparatus can transmit (configure) one or multiple pieces of assistance information for each time index of the synchronization signal block. The terminal apparatus can associate PMI (antenna port number) with the receive beam direction, and thus the base station apparatus can transmit (configure) one or multiple pieces of assistance information for each PMI (antenna port number). In a case that the terminal apparatus includes multiple subarrays, the receive beam direction is likely to vary with subarray, and thus the base station apparatus can transmit (configure) one or multiple pieces of assistance information for each of the indexes associated with the subarrays of the terminal apparatus. For example, the terminal apparatus can associate the TCI with the receive beam direction, and thus the base station apparatus can transmit (configure) one or more pieces of assistance information for each TCI. In a case that multiple base station apparatuses (transmission and/or reception points) communicate with the terminal apparatus, the terminal apparatus is likely to communicate in a receive beam direction different from the receive beam direction for each base station apparatus (transmission and/or reception point). Thus, the base station apparatus transmits (configures) one or multiple pieces of assistance information for each information indicating the base station apparatus (transmission and/or reception point). Information indicating the base station apparatus (transmission and/or reception point) may be a physical cell ID or a virtual cell ID. In a case that the base station apparatus (transmission and/or reception point) uses a different DMRS antenna port number, information indicating the DMRS antenna port number or the DMRS antenna group is used as information indicating the base station apparatus (transmission and/or reception point).

Note that the number of pieces of assistance information configured by the base station apparatus for each CRI/TCI may be common. Here, the number of pieces of assistance information refers to the type of assistance information, the number of elements of each piece of assistance information (e.g., the number of candidates for the cell ID), and the like. A maximum value is configured for the number of pieces of assistance information configured for each CRI/TCI by the base station apparatus, and the base station apparatus can configure the assistance information for each CRI/TCI such that the number of pieces of assistance information is equal to or smaller than the maximum value.

Note that in a case that a value for scheduling offset indicating a scheduling start position of the terminal apparatus is less than or equal to the prescribed value, the terminal apparatus fails to finish decoding of the DCI in time for the reception of the PDSCH. At this time, the terminal apparatus can receive the PDSCH in accordance with a preset default configuration (e.g., TCI default), but in a case that interference suppression is performed, the reception of the PDSCH (configuration of the spatial region receive filter) follows the default configuration in a case that the scheduling offset is less than or equal to a prescribed value. However, for interference suppression, even in a case that the scheduling offset is less than or equal to the prescribed value, the assistance information notified in the DCI can be followed. The base station apparatus can configure the terminal apparatus, receiving the PDSCH in accordance with the TCI default, such that the terminal apparatus does not perform interference suppression on the PDSCH received in accordance with the TCI default. In other words, the terminal apparatus can perform the reception processing oil the PDSCH received in accordance with the TCI default without assuming interference suppression.

Note that, in a case that the receive beam direction of the terminal apparatus varies, the transmit antennas are unlikely to be quasi co-located. Accordingly, the assistance information can be associated with the QCL information. For example, in a case that the base station apparatus transmits (configures) assistance information related to multiple cells, the base station apparatus can indicate quasi-co-located cells (or non-quasi-co-located cells) to the terminal apparatus.

Note that the terminal apparatus removes or suppresses the interference signal by using the assistance information associated with the CRI/TCI used for communication with the serving cell.

The base station apparatus may configure assistance information associated with the receive beam direction (CRI/time index of the synchronization signal block/PMI/antenna port number/subarray/TCI) and assistance information that is not associated with the receive beam direction (CRI/time index of the synchronization signal block/PMI/antenna port number/subarray/TCI). The assistance information associated with the receive beam direction and the assistance information not associated with the receive beam direction may be selectively used for the capability and category of the terminal apparatus. The capability and category of the terminal apparatus may indicate whether the terminal apparatus supports receive beamforming or not. The assistance information associated with the receive beam direction and the assistance information not associated with the receive beam direction may be selectively used in a frequency band. For example, the base station apparatus does not configure the assistance information associated with the receive beam direction at frequencies lower than 6 GHz. For example, the base station apparatus configures the assistance information associated with the receive beam direction only at frequencies higher than 6 GHz.

Note that the CRI may be associated with a CSI resource set configuration ID. In a case of indicating the CRI to the terminal apparatus, the base station apparatus may indicate the CRI along with the CSI resource set configuration ID. Note that in a case that the CSI resource set configuration ID is associated with one piece of CRI or one receive beam direction, the base station apparatus may configure the assistance information for each CSI resource set configuration ID.

In a case that the terminal apparatus removes or suppresses inter-user interference, the base station apparatus desirably indicates to the terminal apparatus that the base station apparatus may provide a multi-user transmission to the terminal apparatus. The multi-user transmission, for which the terminal apparatus needs to remove or suppress interference, is also referred to as multi-user MIMO transmission. Multi User Superposition Transmission, and Non Orthogonal Multiple Access (NOMA) transmission. The base station apparatus can Configure multi user MIMO transmission (MUST or NOMA) configuration information through higher layer signalling. In a case that multi-user MIMO transmission (MUST or NOMA) is configured, the base station apparatus can transmit, in the DCI, interference signal information for removing or suppressing inter-user interference. The interference signal information included in the DCI includes some or all of the presence of the interference signal, a modulation scheme for the interference signal, DMRS port numbers for the interference signal, the number of DMRS CDM groups with no data for the interference signal, the power ratio between the DMRS and the PDSCH, the number of symbols for the front-loaded DMRS, the information indicating the OCC=2 or 4, and the PT-RS information of the interference signal. The multi-user MIMO can be multiplexed up to eight layers for the DMRS configuration type 1 and up to 12 layers for the DMRS configuration type 2. Consequently, the maximum number of interference layers is 7 layers for the DMRS configuration type 1, and 11 layers for the DMRS configuration type 2. Thus, for example, 7 bits in the DMRS configuration type 1 and 11 bits in the DMRS configuration type 2 allow the presence of interference to be indicated for each of the DMRS port, numbers that can cause interference. In addition, 14 bits in the DMRS configuration type 1 and 22 bits in the DMRS configuration type 2 allow indication of the presence of interference and three types of modulation schemes (e.g., QPSK, 16 QAM, and 64 QAM) for each of the DMRS port numbers that can cause interference.

It should be noted that removing or suppressing some dominant interference signals, instead of removing or suppressing all interference layers, is effective for removing or suppressing the interference signals. Accordingly, the base station apparatus can transmit interference signal information for some interference layers. This enables a larger amount of control information to be reduced than transmission of interference signal information for all the interference layers. The base station apparatus can configure the maximum interference layer number through higher layer signalling. In this case, the base station apparatus transmits interference signal information related to interference layers the number of which is equal to or smaller than the maximum interference layer number. At this time, the interference signal information includes information regarding DMRS ports the number of which is equal to or smaller than the maximum interference layer number. Thus, the maximum interference layer number allows consideration of tradeoff between the effect of removal or suppression of interference and the amount of control information. Note that the base station apparatus may configure, through higher layer signalling, a DMRS port group that may cause interference. This enables a reduction in the maximum interference layer number and allows indication of DMRS port numbers that can cause interference. The base station apparatus may configure, through higher layer signaling, a DMRS COM group that may cause interference. This enables a reduction in the maximum interference layer number and allow s indication of DMRS port numbers that can cause interference. In addition, the number of layers that can be multiplexed varies depending on the DMRS configuration type or OCC=2 or 4. Accordingly, the maximum layer number can be associated with the applicable DMRS configuration types and OCC=2 or 4. In this case, the amount of control information can be reduced. For example, a maximum layer number of 4 can indicate OCC=2 for the DMRS configuration type 1. For example, a maximum layer number of 6 can indicate OCC=2 for the DMRS configuration type 2. For example, a maximum layer number of 8 can indicate OCC=2 or 4 for the DMRS configuration type 1. For example, a maximum layer number of 12 can indicate OCC=2 or 4 for the DMRS configuration type 2. Note that candidates for interfering DMRS port numbers vary depending on OCC=2 or 4. For example, in a case of OCC=2 for the DMRS configuration type 1, interfering DMRS port numbers are those of the DMRS port numbers 1000, 1001, 1002, and 1003 which are not used for the subject terminal apparatus. In a case of OCC=2 for the DMRS configuration type 2, interfering DMRS port numbers are those of the DMRS port numbers 1000, 1001, 1002, 1003, 1004, and 1005 which are not used for the subject terminal apparatus.

The base station apparatus can classify the assistance information, providing notification to the terminal apparatus, into first assistance information and second assistance information, and the number of pieces of information included in the first assistance information may have a value different from the value of the number of pieces of information included in the second assistance information. In other words, the amount of information related to the first interference signal and notified in the first assistance information by the base station apparatus can be set greater than the amount of information related to the second interference signal and notified in the second assistance information. For example, the base station apparatus can notify, as the first assistance information, information indicating the modulation order of the interference signal and the DMRS ports, and can notify, as the second assistance information, information indicating the DMRS ports. Such control allows the base station apparatus to suppress overhead related to the notification of the assistance information, while allowing the terminal apparatus to use the first assistance information and the second assistance information. This enables a receive spatial filter to be accurately generated in consideration of the first interference signal and the second interference signal, while enabling generation of a replica signal of the first interference signal with high interference power to implement a non-linear interference canceller.

Note that the assistance information that the base station apparatus notifies to the terminal apparatus may be varied depending on the frequency band in which the base station apparatus configures the component carrier (or BWP). For example, the PT-RS is likely to be transmitted by the base station apparatus in a case of performing high frequency transmission. Accordingly, the base station apparatus can classify frequencies in which component carriers may be configured, into two frequency ranges including a frequency range 1 (FR1) including low frequencies and a frequency range 2 (FR2) including high frequencies, and can set the amount of assistance information associated with a component carrier configured in the frequency range 2 (FR2), greater than the amount of assistance information associated with a component carrier configured in the frequency range 1. For example, the base station apparatus does not include information related to the PT-RS in the assistance information in a case of performing communication in the FR1, and includes information related to the PT-RS in the assistance information in a case of performing communication in the FR2.

The PT-RS is transmitted for each UE. Accordingly, in a case that the PT-RS is transmitted, the terminal apparatus cart recognize the number of PT-RS ports as long as the terminal apparatus can recognize the number of UEs to be multiplexed. Because PT-RS ports are associated with the DMRS ports, the control information increases consistently with the number of PT-RS ports. Thus, in a case that the base station apparatus configures the maximum number of interfering UEs through the higher layer signalling, the number of PT-RS ports can be limited, and the amount of control information can be reduced.

Since the presence of the PT-RS is associated with the modulation scheme (MCS), candidates for the modulation scheme can be limited depending on the presence or absence of the PT-RS. For example, in a case that the base station apparatus makes the PT-RS configuration and that the PT-RS is not transmitted, the modulation scheme for the interference signal is recognized to be QPSK, and in a case that the PT-RS is transmitted, the modulation scheme for the interference signal is recognized to be 16 QAM, 64 QAM, or 256 QAM. Note that the PT-RS is likely to be transmitted in a high frequency band. In the high frequency band, the modulation order tends to be low, and thus in a case of multi user transmission in a high frequency band (e.g., frequency band of 6 GHz or higher), the modulation scheme may be QPSK. In multi-user transmission with a great spatial multiplexing number, the modulation scheme may be QPSK because the modulation order tends to be low. For example, in a case that the maximum interference layer number or the maximum interference UE number exceeds a prescribed number, the modulation scheme may be QPSK. In a case that the modulation scheme is QPSK, the PT-RS is not transmitted, and thus the associated control information can be reduced.

The presence or absence of the PT-RS also depends on the number of RBs allocated. In a case that the number of RBs configured in the terminal apparatus is less than a prescribed value (e.g., 3), the base station apparatus does not configure the PT-RS for the terminal apparatus. Thus, in a case that the number of RBs allocated to the interference signal is less than the prescribed value, the terminal apparatus can perform interference suppression processing assuming that the PT-RS is not configured for the interference signal. For suppression of overhead related to the notification of the PT-RS configuration information, in a case that the configured value for the time density or frequency density of the PT-RS or the configured values for both time density or frequency density of the PT-RS are each greater than or equal to a prescribed value, the base station apparatus can refrain from including the PT-RS configuration information in the assistance information. Note that the time density of the PT-RS is dependent on an MCS configuration. In other words, the base station apparatus can provide a configuration in which, in a case that the MCS configured in the interference signal is greater than or equal to a prescribed value, the base station apparatus does not notify the terminal apparatus of the PT-RS configuration information associated with the interference signal. The frequency density of the PT-RS depends on a scheduled bandwidth. In other words, the base station apparatus can provide a configuration in which, in a case that the bandwidth configured in the interference signal is less than a prescribed value, the base station apparatus does not notify the terminal apparatus of the PT-RS configuration information associated with the interference signal.

Note that the base station apparatus according to the present embodiment can determine the MCS to be configured for the PDSCH by referencing multiple MCS tables. Thus, in a case that the interference information includes an MCS, the base station apparatus can include, in the interference information, information indicating the MCS table referenced by the index indicating the MCS. The terminal apparatus can perform the interference suppression processing assuming that the index indicating the MCS associated with the interference signal references the same MCS table as the MCS table referenced by the index indicating the MCS configured for the PDSCH addressed to the subject terminal apparatus. Similarly, the base station apparatus can include, in the interference information, information indicating a codebook referenced by the index indicating PMI, and the terminal apparatus can perform the interference suppression processing assuming that the codebook referenced by the index indicating the PMI references the same codebook as that which is referenced by the PMI notified to the subject terminal apparatus.

In a case that the base station apparatus makes a PT-RS configuration and a multi-user transmission configuration, the terminal apparatus may assume that the number of front-loaded DMRS symbols is 1 (OCC=2). In this case, the PT-RS configuration can limit the number of DMRS ports and port numbers used as candidates for interference. In a case that the base station apparatus makes a PT-RS configuration and a multi-user transmission configuration and that the number of front-loaded DMRS symbols addressed to the subject apparatus is 2, the terminal apparatus may assume that there is no inter-user interference.

For suppression of control information related to the resource allocation for the interference signal (addressed to the other apparatus), resource allocation addressed to the subject apparatus is desirably included in the resource allocation for the interference signal (addressed to other apparatuses). Accordingly, in a case that the multi-user transmission is configured, the terminal apparatus assumes, for the subject apparatus, some or all of the same PDSCH mapping type, the same DMRS configuration type, and the same number of front-loaded DMRS symbols as those for the interference signal.

Note that the frequency bands used by the communication apparatus (base station apparatus and terminal apparatus) according to the present embodiment are not limited to the licensed bands or unlicensed bands described heretofore. Frequency bands to which the present embodiment is directed include frequency bauds referred to as white bands (white space) that have been nationally or regionally licensed for particular services but that are actually unused for the purpose of, for example, preventing cross talk between frequencies (e.g. frequency bands that have been allocated for television broadcasting but that are not used in some regions) or shared frequency bands (licensed shared bands) that have been exclusively allocated to a particular operator but that are expected to be shared by multiple operators in the future.

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gale Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use a new integrated circuit based on the technology according to one or more aspects of the present invention.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that docs not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, ate substituted for one another is also included in the technical scope of the present invention.

### INDUSTRIAL APPLICABILITY

An aspect of the present invention can be preferably used in a base station apparatus, a terminal apparatus, and a communication method.

1. A terminal apparatus for communicating with a base station apparatus, the terminal apparatus comprising:
a higher layer processing unit configured to be configured with a channel state information (CSI) report configuration;
a measurement unit configured to calculate CSI; and
a transmitter configured to transmit a CSI report,
wherein, in a case that, in the CSI report configuration, a report quantity is configured so as to report a CSI-RS resource indicator (CRI), a rank indicator (RI), and a channel quality indicator (CQI),
for a first CSI-RS resource and a second CSI-RS resource, first and second CRIs being included in multiple CSI-RS resources configured in a CSI-RS resource set, and being simultaneously receivable by the terminal apparatus, a first RI for the first CSI-RS resource and a second RI for the second CSI-RS resource are determined,
in a case that a total of the first RI and the second RI is four or less, a CQI determined by using both the first CSI-RS resource and the second CSI-RS resource is determined, and
the CSI report includes the first CRI indicating the first CSI-RS resource, the second CRI indicating the second CSI-RS resource, the first RI, the second RI, and the CQI.

2. (canceled)

3. The terminal apparatus according to claim 1, wherein
in a case that, in the CSI report configuration, the report quantity is configured so as to report the CRI, the RI, a precoding matrix indicator (PMI), and the CQI, a first PMI for the first CSI-RS resource and a second PMI for the second CSI-RS resource are further determined, and
the first PMI and the second PMI are calculated in consideration of both the first CSI-RS resource and the second CSI-RS resource.

4. The terminal apparatus according to claim 1, wherein
a difference between the first RI and the second RI is zero or one.

5. The terminal apparatus according to claim 1, wherein
in a case that a difference between the first RI and the second RI is other than zero or one, the CSI based on one of the first CSI-RS resource and the second CSI-RS resource is reported.

6. The terminal apparatus according to claim 5, wherein
information indicating whether to report the CSI based on one CSI-RS resource or to report the CSI based on two CSI-RS resources is included in the CSI report.

7. A base station apparatus for communicating with a terminal apparatus, the base station apparatus comprising:
a higher layer processing unit configured with a channel state information (CSI) report configuration; and
a receiver configured to receive a CSI report,
wherein, in a case that, in the CSI report configuration, a report quantity is configured so as to report a CSI-RS resource indicator (CRI), a rank indicator (RI), and a channel quality indicator (CQI),
for a first CSI-RS resource and a second CSI-RS resource, first and second CRIs being included in multiple CSI-RS resources configured in a CSI-RS resource set, and being simultaneously receivable by the terminal apparatus, information indicating the first CRI which indicates the first CSI-RS resource and the second CRI which indicates the second CSI-RS resource, and information indicating a first RI for the first CSI-RS resource and a second RI for the second CSI-RS resource is received, and
in a case that a total of the first RI and the second RI is four or less, information indicating a CQI determined by using both the first CSI-RS resource and the second CSI-RS resource is received.

8. The base station apparatus according to claim 7, wherein
in a case that the total of the first RI and the second RI is greater than four,
information indicating the first CRI and the second CRI is received,
information indicating the first RI and the second RI is received, and
information indicating a first CQI calculated by the first CSI-RS, and a second CQI calculated by the second CSI-RS.

9. The base station apparatus according to claim 7, wherein
in a case that, in the CSI report configuration, the report quantity is configured so as to report the CRI, the RI, a precoding matrix indicator (PMI), and the CQI, information indicating a first PMI for the first CSI-RS resource and a second PMI for the second CSI-RS resource is further received, and
the first PMI and the second PMI are calculated in consideration of both the first CSI-RS resource and the second CSI-RS resource.

10. The base station apparatus according to claim 7, wherein
a difference between the first RI and the second RI is zero or one.

11. The base station apparatus according to claim 7, wherein
in a case that a difference between the first RI and the second RI is other than zero or one, either the CSI based on the first CSI-RS resource or the CSI based on the second CSI-RS resource is received.

12. The base station apparatus according to claim 11, wherein
information indicating whether to report the CSI based on one CSI-RS resource or to report the CSI based on two CSI-RS resources is received.

13. A communication method in a terminal apparatus for communicating with a base station apparatus, the communication method comprising the steps of:
causing a channel state information (CSI) report configuration to be configured;
calculating CSI; and
transmitting a CSI report,
wherein, in a case that, in the CSI report configuration, a report quantity is configured so as to report a CSI-RS resource indicator (CRI), a rank indicator (RI), and a channel quality indicator (CQI),
for a first CSI-RS resource and a second CSI-RS resource, first and second CRIs being included in multiple CSI-RS resources configured in a CSI-RS resource set, and being simultaneously receivable by the terminal apparatus, a first RI for the first CSI-RS resource and a second RI for the second CSI-RS resource are determined,
in a case that a total of the first RI and the second RI is four or less, a CQI determined by using both the first CSI-RS resource and the second CSI-RS resource is determined, and
the CSI report includes the first CRI indicating the first CSI-RS resource, the second CRI indicating the second CSI-RS resource, the first RI, the second RI, and the CQI.

14. A communication method in a base station apparatus for communicating with a terminal apparatus, the communication method comprising the steps of:
causing a channel state information (CSI) report configuration to be configured; and
receiving a CSI report,
wherein, in a case that, in the CSI report configuration, a report quantity is configured so as to report a CSI-RS resource indicator (CRI), a rank indicator (RI), and a channel quality indicator (CQI),
for a first CSI-RS resource and a second CSI-RS resource, first and second CRIs being included in multiple CSI-RS resources configured in a CSI-RS resource set, and being simultaneously receivable by the terminal apparatus, information indicating the first CRI which indicates the first CSI-RS resource and the second CRI which indicates the second CSI-RS resource, and information indicating a first RI for the first CSI-RS resource and a second RI for the second CSI-RS resource is received, and
in a case that a total of the first RI and the second RI is four or less, information indicating a CQI determined by using both the first CSI-RS resource and the second CSI-RS resource is received.
